(19) United States
(12) Patent Application Publication
(10) Pub. No.: US 2023/0012409 A1
(43) Pub. Date: Jan. 12, 2023

(54) SYSTEM, CONTROL METHOD OF SYSTEM, AND STORAGE MEDIUM

(71) Applicant: CANON KABUSHIKI KAISHA, Tokyo (JP)

(72) Inventor: Naoki Maruyama, Ibaraki (JP)

(21) Appl. No.: 17/859,691

(22) Filed: Jul. 7, 2022

(30) Foreign Application Priority Data
Jul. 12, 2021 (JP) 2021-114970

(51) Int. Cl. G09B 7/06; G09B 7/02; H04N 1/00

(52) U.S. Cl. CPC G09B 7/06; G09B 7/02; H04N 1/00376

(57) ABSTRACT

A system includes a print unit configured to print an answer sheet including a plurality of free-form answer fields and a plurality of marking fields, the plurality of marking fields being configured to mark answers written in the respective plurality of free-form answer fields, a reading unit configured to read the answer sheet printed by the print unit, a marking unit configured to mark the answers based at least on description of the plurality of marking fields included in the answer sheet read by the reading unit, and an aggregation unit configured to aggregate results of marking made by the marking unit.

### BACKGROUND

### Field of the Disclosure

The present disclosure relates to a system, a control method for the system, and a storage medium.

### Description of the Related Art

There has recently been an education support system that prints test answer sheets, and scans and marks filled-out answer sheets (see Japanese Patent Application Laid-Open No. 2005-24693).

The use of such a system can automate aggregation of marking results, which has heretofore been manually performed. The time saved can be used for other operations.

An answer sheet can include multiple-choice answer fields and free-form answer fields.

A method discussed in Japanese Patent Application Laid-Open No. 2005-24693 can mark answers and aggregate the marking results.

However, the foregoing system can provide only one free-form answer field and one mark-up field, not a plurality of free-form answer fields.

It has therefore been difficult to recognize marking results of a plurality of free-form questions question by question by scanning such an answer sheet.

### SUMMARY

According to an aspect of the present disclosure, a system includes a print unit configured to print an answer sheet including a plurality of free-form answer fields and a plurality of marking fields, the plurality of marking fields being configured to mark answers written in the respective plurality of free-form answer fields, a reading unit configured to read the answer sheet printed by the print unit, a marking unit configured to mark the answers based at least on description of the plurality of marking fields included in the answer sheet read by the reading unit, and an aggregation unit configured to aggregate results of marking made by the marking unit.

Further features of various embodiments will become apparent from the following description of exemplary embodiments with reference to the attached drawings.

### BRIEF DESCRIPTION OF THE DRAWINGS

FIGS. 1A and 1B illustrate the configuration of a multifunction peripheral according to a first exemplary embodiment of the present disclosure and examples of screens displayed on an operation unit.

FIGS. 2A-B illustrate answer sheet data according to the first exemplary embodiment of the present disclosure and an example of an answer sheet pattern configuration for describing elements constituting an answer sheet.

FIGS. 3A-B illustrate-the configuration of an answer sheet pattern database (DB) according to the first exemplary embodiment of the present disclosure and examples of answer sheet pattern marker information, answer sheet pattern data, and detailed data associated with the same.

FIGS. 4A and 4B are flowcharts related to a preview and print control of an answer sheet according to the first exemplary embodiment of the present disclosure.

FIGS. 5A to 5G are flowcharts related to generation of an answer sheet and generation and drawing of answer sheet pattern data according to the first exemplary embodiment of the present disclosure.

FIGS. 6A and 6B are flowcharts of processing performed when a marking and aggregation button is pressed in the first exemplary embodiment of the present disclosure.

FIGS. 7A to 7G are flowcharts related to marking processing and score obtaining processing during the marking processing according to the first exemplary embodiment of the present disclosure.

FIG. 8 illustrates a system configuration according to a second exemplary embodiment of the present disclosure and an example of a screen displayed on an operation unit (answer sheet marking and aggregation screen).

FIGS. 9A to 9D are flowcharts related to processing for drawing answer sheet pattern data, acquisition of answer sheet data from an external education system, and mark-up field composite print processing according to the second exemplary embodiment of the present disclosure.

FIGS. 10A-B illustrate examples of screens displayed on an operation unit (answer sheet generation and print screen and associated setting screens) according to a third exemplary embodiment of the present disclosure.

FIG. 11 illustrates an example of answer sheet pattern data according to the third exemplary embodiment of the present disclosure.

FIG. 12 is a flowchart related to point information obtaining processing according to the third exemplary embodiment of the present disclosure.

FIGS. 13A-B illustrate examples of screens displayed on an operation unit (setting screens associated with an answer sheet generation and print screen) according to a fourth exemplary embodiment of the present disclosure.

FIGS. 14A-C illustrate examples of detailed data on answer sheet pattern data and grade area configuration diagrams according to the fourth exemplary embodiment of the present disclosure.

FIGS. 15A and 15B are flowcharts related to score obtaining processing according to the fourth exemplary embodiment of the present disclosure.

FIGS. 16A-C illustrate examples of detailed data about answer sheet pattern data and grade area configuration diagrams according to a fifth exemplary embodiment of the present disclosure.

FIGS. 17A to 17D are flowcharts related to marking result obtaining processing according to the fifth exemplary embodiment of the present disclosure.

FIG. 18 is a diagram illustrating examples of screens displayed on an operation unit (setting screens associated with an answer sheet generation and print screen) according to a sixth exemplary embodiment of the present disclosure.

FIG. 19 is a flowchart related to question rearrangement processing according to the sixth exemplary embodiment of the present disclosure.

FIGS. 20A-B illustrates examples of screens displayed on an operation unit (setting screens associated with an answer sheet generation and print screen) according to a seventh exemplary embodiment of the present disclosure.

FIGS. 21A and 21B are flowcharts related to marking processing according to an eighth exemplary embodiment of the present disclosure.

FIGS. 22A to 22D are flowcharts related to index area analysis and registration processing on answer sheet pattern data according to the eighth exemplary embodiment of the present disclosure.

FIGS. 23A to 23C are flowcharts related to question type determination processing on answer sheet pattern data according to the eighth exemplary embodiment of the present disclosure.

FIGS. 24A to 24E are flowcharts related to data area identification processing and question type-specific data area registration processing on answer sheet pattern data according to the eighth exemplary embodiment of the present disclosure.

FIGS. 25A to 25E are flowcharts related to grade area information detail calculation and registration processing according to the eighth exemplary embodiment of the present disclosure.

### DESCRIPTION OF THE EMBODIMENTS

Some exemplary embodiments of the present disclosure will be described below with reference to the drawings. The following exemplary embodiments are not intended to limit the claims, and not all combinations of features described in the exemplary embodiments are used as the solving means of the present disclosure.

In a first exemplary embodiment, a case where a multifunction peripheral 100 is used as a marking system will be described as an example.

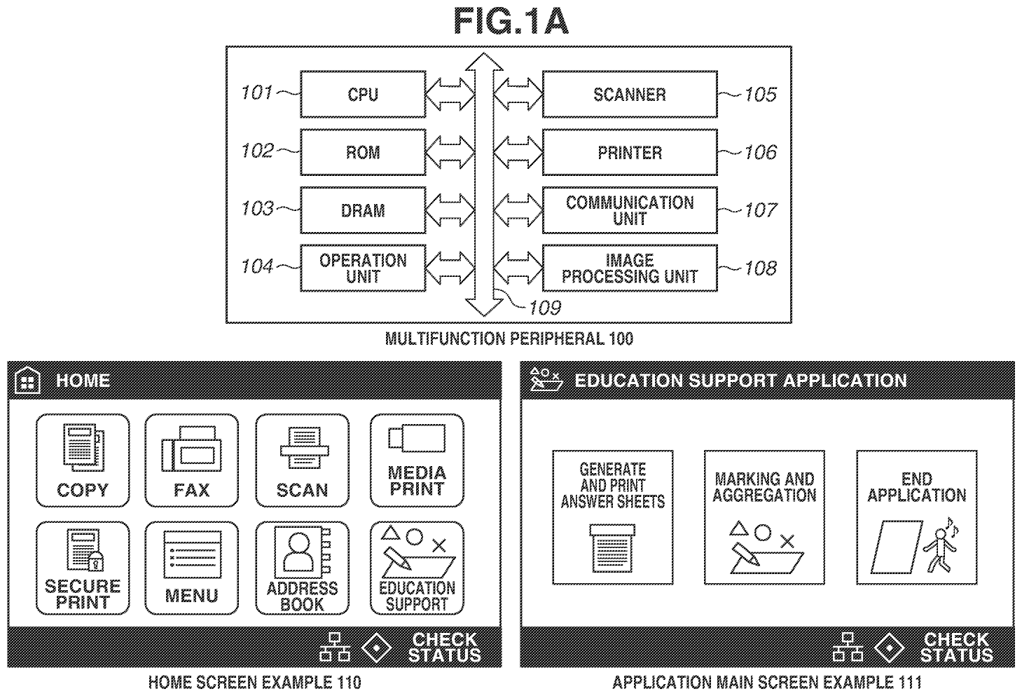

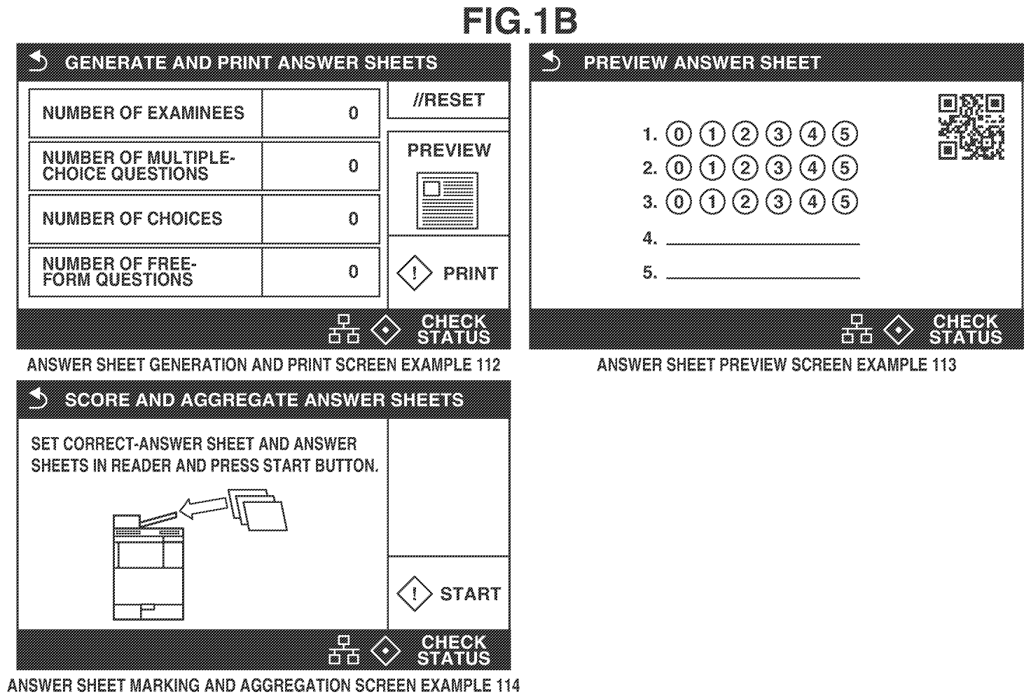

FIGS. 1A and 1B illustrate a configuration example of the multifunction peripheral 100.

A central processing unit (CPU) 101 is a system control unit, and generally controls the multifunction peripheral 100.

The CPU 101 reads control programs stored in a read-only memory (ROM) 102 and runs the programs. The ROM 102 includes a flash memory, such as an embedded MultiMediaCard (eMMC), and is intended to store the control programs for the CPU 101. The ROM 102 also stores image data.

A dynamic random access memory (DRAM) 103 is intended to store program control variables. The DRAM 103 is a volatile memory capable of temporarily storing image data to be processed.

An operation unit 104 functions as a user interface unit. The operation unit 104 includes a touch panel including a liquid crystal display unit to which a touch panel sheet for accepting user operations is attached. The operation unit 104 displays various screens and information on the touch panel. The operation unit 104 also includes hardware keys, such as a start key and a reset key.

A scanner 105 is a device for reading image data and converting the image data into binary data. The scanner 105 is used to read documents as a part of an image transmission function.

A printer 106 is a device that performs fixing temperature control to fix image data to a recording sheet, and outputs the recording sheet.

A communication unit 107 is an interface unit between the multifunction peripheral 100 and an external communication network. The communication unit 107 includes a network communication unit that is an interface with a network.

An image processing unit 108 includes an application-specific integrated circuit (ASIC) for performing image processing on input and output image data. Examples of the image processing include resolution conversion, compression and decompression, and rotation.

The foregoing components are connected to one another via a data bus 109.

Next, examples of screens displayed on the multifunction peripheral 100 will be described.

A home screen example 110 in FIG. 1A is an example of a screen (home screen) displayed on the operation unit 104. This screen is displayed on the operation unit 104 immediately after startup of the multifunction peripheral 100. The user can display screens registered in icons displayed on this screen by tapping on the icons. Various functions implemented on the multifunction peripheral 100 are enabled by making various settings on the displayed screens. The user can execute an education support application for implementing control according to the present exemplary embodiment using the operation unit 104.

An application main screen example 111 in FIG. 1A is an example of an education support application screen (application main screen) displayed on the operation unit 104. This screen is displayed by an education support button being pressed on the home screen illustrated in the home screen example 110. On this screen, the user can give instructions to perform an answer sheet generation and print function and a marking and aggregation function for the multifunction peripheral 100 to implement. The user can also terminate the education support application and return to the home screen illustrated in the home screen example 110.

An answer sheet generation and print screen example 112 in FIG. 1B is an example of an answer sheet generation and print function screen (hereinafter, referred to simply as a generation and print function screen 112) of the education support application displayed on the operation unit 104. The generation and print function screen 112 is displayed by an answer sheet generation and print button being pressed in the application main screen example 111. On this generation and print function screen 112, the number of examinees, and the number of multiple-choice questions, the number of choices, and the number of free-form questions constituting answer sheet data are accepted from the user. The generation and print function screen 112 also displays a preview button for giving an instruction to preview the answer sheet data generated based on the setting values, and a print button for giving an instruction to perform printing based on the answer sheet data. The generation and print function screen 112 also displays a reset button for giving an instruction to reset the setting values and restore initial values.

An answer sheet preview screen example 113 in FIG. 1B is an example of a preview screen of the answer sheet data generated based on the setting values set on the generation and print function screen in FIG. 1B. The preview screen is displayed by the preview button on the generation and print function screen being pressed. The generated answer sheet data is displayed on the operation unit 104, and the image of the answer sheet is scrolled from top to bottom in response to touch control as with ordinary preview control. The preview display can be scrolled using scroll keys included in the operation unit 104.

The marker (teacher) hands out the answer sheets printed by the multifunction peripheral 100 to answerers (students). The marker fills out the first answer sheet with correct answers. The marker hands out the second and subsequent answer sheets to the answerers. After the answerers fill out the answer sheets, the marker collects the answer sheets from the answerers, and marks the answers to the free-form questions. The marker makes the multifunction peripheral 100 read the correct-answer sheet and the answer sheets, with the correct-answer sheet as the first sheet and the answer sheets the second and subsequent sheets.

An answer sheet marking and aggregation screen example 114 in FIG. 1B is an example of a screen used in reading the answer sheets. This answer sheet marking and aggregation screen is displayed by a marking and aggregation button being pressed on the application main screen. The user can make the scanner 105 scan the correct-answer sheet and the answer sheets set thereon by pressing a start button on the answer sheet marking and aggregation screen. The multifunction peripheral 100 marks the answers to the multiple-choice questions and aggregates the markings of the answers to the multiple-choice questions made by the multifunction peripheral 100 and the markings of the answers to the free-form questions made by the marker based on the correct-answer sheet and the answer sheets scanned.

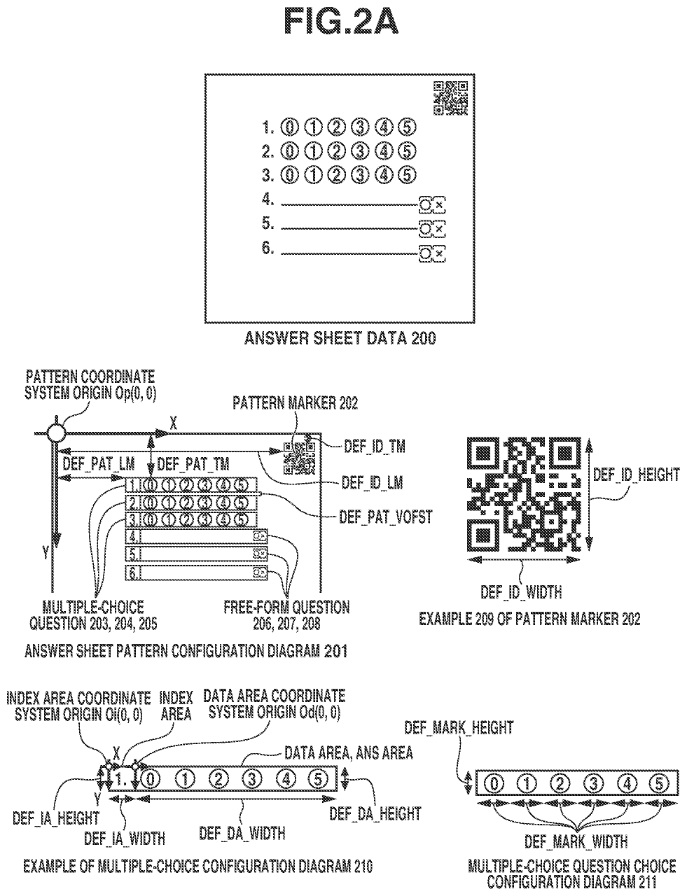

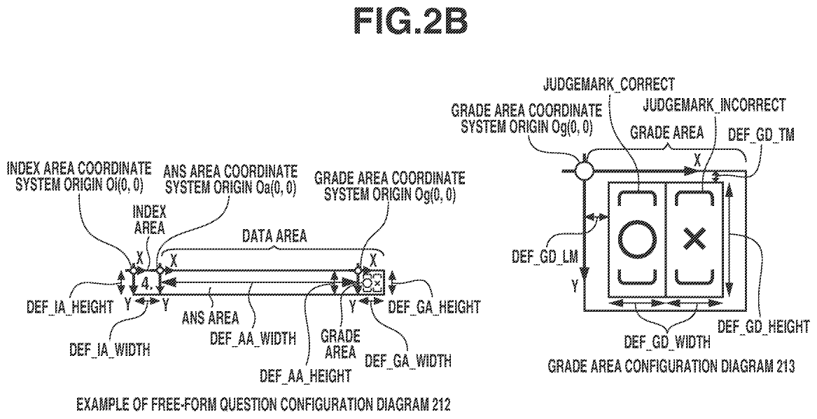

Answer sheet data 200 illustrated in FIG. 2A is an example of the answer sheet data generated based on the setting values set in the answer sheet generation and print screen example 112. In this example, the number of multiple-choice questions is set to three, the number of choices six, and the number of free-form questions three. It can be seen that questions Nos. 1 to 3 are multiple-choice questions with six choices 0 to 5 and questions Nos. 4 to 6 are free-form questions as set by the setting values.

A two-dimensional code for identifying answer sheet information about whether the sheet type is a correct-answer sheet or an answer sheet is attached to the answer sheet data 200. An example of the answer sheet information is a generated answer sheet pattern identifier (ID). While a Quick Response (QR) Code® is attached as an example here, two-dimensional codes of other forms (such as Data Matrix and MaxiCode) may be used.

An answer sheet pattern configuration diagram 201, an example 209 of a pattern marker 202, an example 210 of a multiple-choice question configuration diagram, a multiple-choice question choice configuration diagram 211, an example 212 of a free-form question configuration diagram, and a grade area configuration diagram 213 illustrated in FIGS. 2A and 2B will be described.

These diagrams and examples illustrate the elements constituting an example of answer sheet data illustrated as the answer sheet data 200. As illustrated in the answer sheet pattern configuration diagram 201, a pattern coordinate system origin Op is set at the top left of the answer sheet data. In such a case, a two-dimensional code for identifying the answer sheet information, called pattern marker 202, is drawn at a position offset by DEF_ID_LM in an X direction and DEF_ID_TM in a Y direction. Multiple-choice questions 203 to 205 and free-form questions 206 to 208 are drawn DEF_PAT_VOFST apart from each other in the Y direction, starting at a position offset by DEF_PAT_LM in the X direction and DEF_PAT_TM in the Y direction.

The pattern marker 202 drawn as described above has a size of DEF_ID_WIDTH in width and DEF_ID_HEIGHT in height as illustrated in the example 209 of the pattern marker 202.

The multiple-choice questions 203 to 205 are configured as in the example 210 of the multiple-choice question configuration diagram, each including an index area indicating a question number, a data area indicating choices to the question, and an answer area (hereinafter, referred to as an ans area) to be filled with an answer. The index area includes an element indicating the question number, drawn within an area of DEF_IA_WIDTH in width and DEF_IA_HEIGHT in height with the top left of the index area as the origin of the coordinate system. The data area is an area of DEF_DA_WIDTH in width and DEF_DA_HEIGHT in height, with the top left of the data area as the origin of the coordinate system. As illustrated in the multiple-choice question choice configuration diagram 211, choice elements having a width of DEF_MARK_WIDTH and a height of DEF_MARK_HEIGHT are drawn in the data area. In the case of the multiple-choice questions 203 to 205, the ans area agrees with the data area.

The free-form questions 206 to 208 are configured as illustrated in the example 212 of the free-form question configuration diagram. Like the multiple-choice questions 203 to 205, the free-form questions 206 to 208 each include an index area indicating the question number and a data area indicating a question answer field. However, unlike the multiple-choice questions 203 to 205, the data area is clearly divided between an ans area including a free-form answer field and a grade area including a mark-up field (an example of a marking field). The ans area is an area having a width of DEF_AA_WIDTH and a height of DEF_AA_HEIGHT with the top left of the data area as the origin of the coordinate system like the data area. A line representing the free-form answer field is drawn at the bottom of the ans area. The grade area includes a grade mark field drawn within an area of DEF_GA_WIDTH in width and DEF_GA_HEIGHT in height, with coordinates offset by DEF_AA_WIDTH in the X direction from the data area coordinate system origin as its coordinate system origin.

The mark-up field is configured as illustrated in the grade area configuration diagram 213. Marking marks having a size of DEF_GD_WIDTH in width and DEF_GD_HEIGHT in height are drawn, starting at the position offset by DEF_GD_LM in the X direction and DEF_GD_TM in the Y direction from the grade coordinate system origin. In the illustrated case, JUDGEMARK_CORRECT indicating a correct answer ∘ and JUDGEMARK_INCORRECT indicating an incorrect answer x are drawn as an example.

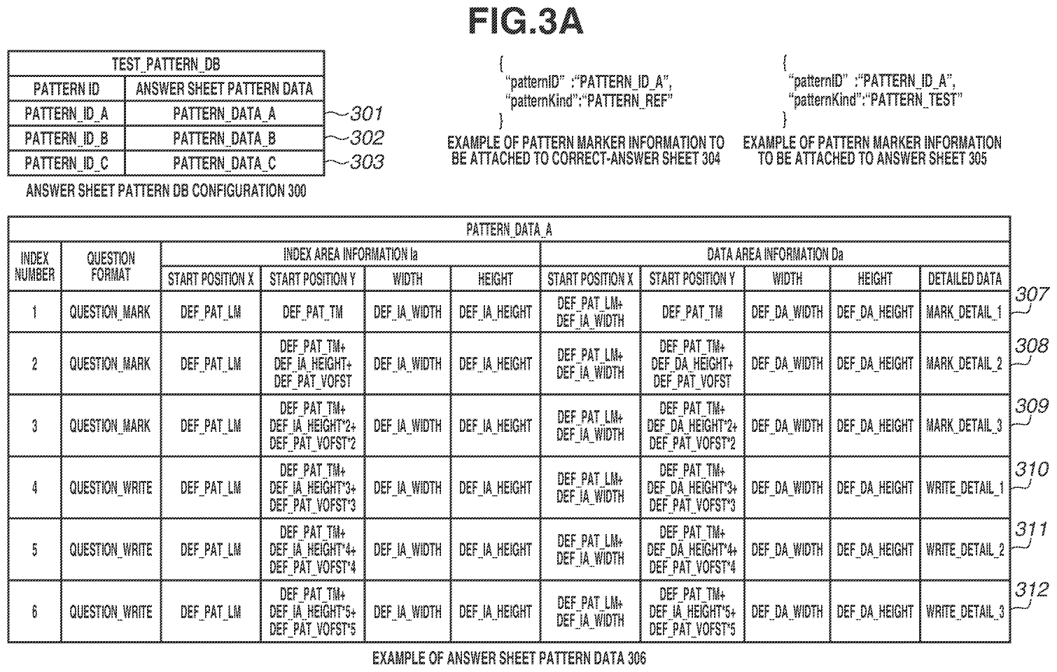

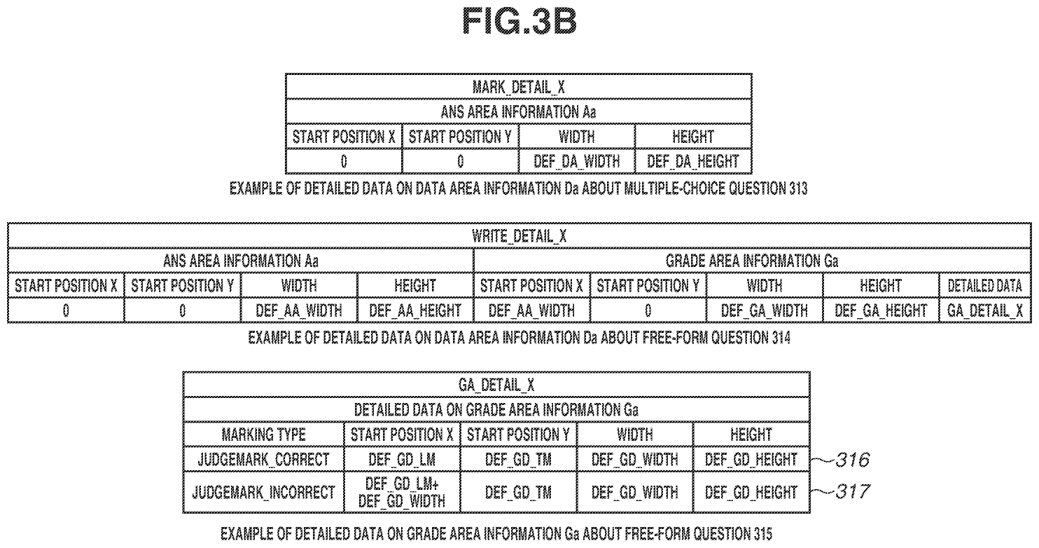

An answer sheet pattern database (DB) configuration 300, an example 304 of pattern marker information to be attached to a correct-answer sheet, and an example 305 of pattern marker information to be attached to an answer sheet in FIG. 3A will be described.

In the present exemplary embodiment, in generating answer sheet data, the pattern configuration illustrated in the answer sheet pattern configuration diagram 201 of FIG. 2A is stored in the DRAM 103 or the ROM 102 in the form of a DB illustrated in the answer sheet pattern DB configuration 300. For example, elements 301 to 303 constituting the answer sheet pattern DB configuration 300 are each given a uniquely defined pattern ID, such as a universally unique identifier (UUID), and paired with answer sheet pattern data.

The example 304 of pattern marker information to be attached to a correct-answer sheet and the pattern marker information 305 to be attached to an answer sheet, generated by using the answer sheet pattern data on the element 301 will now be described. The example 304 of pattern marker information to be attached to a correct-answer sheet includes PATTERN_ID_A as patternID data. PATTERN_ID_A serves as a key in obtaining PATTERN_DATA_A indicated by the element 301. The example 304 of pattern marker information also includes PATTERN_REF as patternKind data. PATTERN_REF indicates that the sheet to which this marker is attached is a correct-answer sheet. A generic format, such as JavaScript Object Notation (JSON) format, which is described as an example in the present exemplary embodiment, is applied to the data. The same applies to the example 305 of pattern marker information to be applied to an answer sheet. The only difference is that PATTERN_TEST indicating that the sheet to which this maker is attached is an answer sheet is included as the pattenKind data.

With such a configuration, if a plurality of pieces of answer sheet data 200 is generated by the multifunction peripheral 100, the pattern marker 202 can be decoded to obtain patternID data, and corresponding desired answer sheet pattern data can be obtained using the patternID data. Information to be used for marking and aggregation, such as the numbers and positions of multiple-choice questions and free-form questions in the test, can be obtained from the obtained answer sheet pattern data.

Now, an example 306 of answer sheet pattern data and an example 313 of detailed data on data area information Da about a multiple-choice question in FIGS. 3A and 3B will be described. An example 314 of detailed data on data area information Da about a free-form question and an example 315 of detailed data on grade area information Ga about a free-form question will also be described.

The example 306 of answer sheet pattern data is an example of answer sheet pattern data when the answer sheet pattern configuration diagram 201 illustrated in FIG. 2A is taken as an example. The example 313 of detailed data on data area information Da about a multiple-choice question, the example 314 of detailed data on data area information Da about a free-form question, and the example 315 of detailed data on grade area information Ga about a free-form question are illustrated as the detailed data on the answer sheet pattern data.

The example 306 of answer sheet pattern data is a specific example of the answer sheet pattern data PATTERN_DATA_A stored in the element 301 of the answer sheet pattern DB configuration 300. Here, the multiple-choice questions 203 to 205 and the free-form questions 206 to 208 in the answer sheet pattern configuration diagram 201 illustrated in FIG. 2A are here illustrated as elements 307 to 309 and elements 310 to 312, respectively. The example 306 also includes an index number, a question format, index area information Ia, and data area information Da constituting each question.

As described above, the element 307 represents the multiple-choice question 203, where an index number of 1 is assigned and the question format is QUESTION_MARK indicating a multiple-choice question. The index area information Ia includes DEF_PAT_LM as the X coordinate of the start position (hereinafter, may be referred to as a start position X), DEF_PAT_TM as the Y coordinate of the start position (hereinafter, may be referred to as a start position Y), DEF_IA_WIDTH as the width, and DEF_IA_HEIGHT as the height. The data area information Da includes DEF_PAT_LM+DEF_IA_WIDTH as the X coordinate of the start position, DEF_PAT_TM as the Y coordinate, DEF_DA_WIDTH as the width, and DEF_DA_HEIGHT as the height. Moreover, MARK_DETAIL_1 to be described below is included as detailed data on the data area information Da.

The elements 308 and 309 represent the multiple-choice questions 204 and 205, respectively, and have basically similar content to that of the element 307.

Differences of the element 308 from the element 307 will be described. The multiple-choice question 204 is assigned an index number of 2 and located below the multiple-choice question 203. The Y coordinates of the start positions in the index area information Ia and the data area information Da are thus set to DEF_PAT_TM+DEF_IA_HEIGHT+DEF_PAT_VOFST, i.e., where the height of the multiple-choice question 203 and a distance offset are added. MARK_DETAIL_2 is included as detailed data on the data area information Da.

Differences of the element 309 from the element 307 will be described. The multiple-choice question 205 is assigned an index number of 3 and located below the multiple-choice questions 203 and 204. The Y coordinates of the start positions in the index area information Ia and the data area information Da are thus set to which the heights of the multiple-choice questions 203 and 204 and the distance offsets are added.

Specifically, the Y coordinates are set to DEF_PAT_TM+DEF_IA_HEIGHT*2+DEF_PAT_VOFST*2. MARK_DETAIL_3 is included as detailed data on the data area information Da.

The element 310 represents the free-form question 206. The assigned index number is 4, and the question format is QUESTION_WRITE indicating a free-form question. The X coordinate of the start position in the index area information Ia is set to DEF_PAT_LM. Since the free-form question 206 is located below the multiple-choice questions 203 to 205, the Y coordinate is set to DEF_PAT_TM+DEF_IA_HEIGHT*3+DEF_PAT_VOFST*3, i.e., where the heights of the multiple-choice questions 203 to 205 and the distance offsets are added. The X coordinate of the start position in the data area information Da is set to DEF_PAT_LM+DEF_IA_WIDTH. Like the index area information Ia, since the free-form question 206 is located below the multiple-choice questions 203 to 205, the Y coordinate in the data area information Da is set to which the heights of the multiple-choice questions 203 to 205 and the distance offsets are added. Specifically, the Y coordinate is set to DEF_PAT_TM+DEF_IA_HEIGHT*3+DEF_PAT_VOFST*3. The width is DEF_DA_WIDTH, and the height is DEF_DA_HEIGHT. Moreover, WRITE_DETAIL_1 to be described below is included as detailed data on the data area information Da.

The elements 311 and 312 represent the free-form questions 207 and 208, respectively, and have basically similar content to that of the element 310.

Differences of the element 311 from the element 310 will be described. The free-form question 207 is assigned an index number of 5 and located below the multiple-choice questions 203 to 205 and the free-form question 206. The Y coordinates of the start positions in the index area information Ia and the data area information Da are thus set to DEF_PAT_TM+DEF_IA_HEIGHT*4+DEF_PAT_VOFST*4. WRITE_DETAIL_2 is included as detailed data on the data area information Da.

Differences of the element 312 from the element 310 will be described. The free-form question 208 is assigned an index number of 6 and located below the multiple-choice questions 203 to 205 and the free-form questions 206 and 207. The Y coordinates of the start positions in the index area information Ia and the data area information Da are thus set to DEF_PAT_TM+DEF_IA_HEIGHT*5+DEF_PAT_VOFST*5. WRITE_DETAIL_3 is included as detailed data on the data area information Da.

The example 313 of the detailed data on the data area information Da about a multiple-choice question is a specific example of MARK_DETAIL_1 to MARK_DETAIL_3 included in the foregoing elements 307 to 309. The data area of a multiple-choice question includes only the ans area. The X and Y coordinates of the start position in ans area information Aa, expressed by relative coordinates with respect to the data area coordinate system origin, are hence 0. The width is DEF_DA_WIDTH, and the height is DEF_DA_HEIGHT.

The example 314 of the detailed data on the data area information Da about a free-form question is a specific example of WRITE_DETAIL_1 to WRITE_DETAIL_3 included in the foregoing elements 310 to 312. The data area of a free-form question includes the ans area and the grade area. As with the multiple-choice questions, the coordinates of the areas are expressed by relative coordinates with respect to the data area coordinate system origin. The X and Y coordinates of the start position in the ans area information Aa are hence 0. The width is DEF_AA_WIDTH, and the height is DEF_AA_HEIGHT. The X coordinate of the start position in the grade area information Ga is DEF_AA_WIDTH, i.e., shifted as much as the ans area in the X direction. The Y coordinate is 0. The width is DEF_GA_WIDTH, and the height is DEF_GA_HEIGHT. GA_DETAIL_X is included as detailed data on the grade area information Ga.

The example 315 of the detailed data on the grade area information Ga about a free-form question is a specific example of the foregoing GA_DETAIL_X. Elements 316 and 317 indicate information about areas where JUDGEMARK_CORRECT and JUDGEMARK_INCORRECT are drawn in the grade area configuration diagram 213, respectively.

The element 316 includes JUDGEMARK_CORRECT representing a correct answer ∘ as a marking type. The X and Y coordinates of the start position expressed by relative coordinates with respect to the grade area coordinate system origin are DEF_GD_LM and DEF_GD_TM, respectively. The width is DEF_GD_WIDTH, and the height is DEF_GD_HEIGHT.

The element 317 includes JUDGEMARK_INCORRECT representing an incorrect answer x as the marking type. The X and Y coordinates of the start position expressed by relative coordinates with respect to the grade area coordinate system origin are DEF_GD_LM+DEF_GD_WIDTH and DEF_GD_TM, respectively. The width is DEF_GD_WIDTH, and the height is DEF_GD_HEIGHT.

In the present exemplary embodiment, in marking and aggregating answers, the areas are identified and processed by referring to the index area information Ia and the data area information Da about each question included in the foregoing answer sheet pattern data.

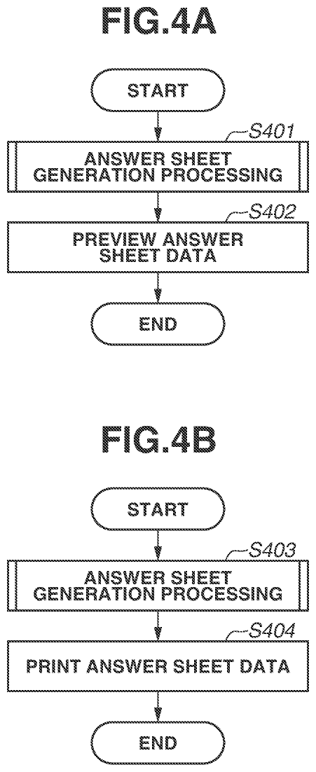

FIG. 4A illustrates a flowchart of processing performed when a preview execution instruction is given in the answer sheet generation and print screen example 112 illustrated in FIG. 1B. The processing of this flowchart is performed by the CPU 101 reading a program stored in the ROM 102 into the DRAM 103 and running the program. Answer sheet data is generated and previewed by the processing of this flowchart.

In step S401, the CPU 101 generates answer sheet DATA (answer sheet generation processing). The processing proceeds to step S402. Details of the answer sheet generation processing will be described below with reference to another flowchart.

In step S402, the CPU 101 previews the generated answer sheet data on the operation unit 104. The processing of this flowchart ends.

FIG. 4B illustrates a flowchart of processing performed when a print execution instruction is given in the answer sheet generation and print screen example 112 illustrated in FIG. 1B. The processing of this flowchart is performed by the CPU 101 reading a program stored in the ROM 102 into the DRAM 103 and running the program. Answer sheet data is generated and printed by the processing of this flowchart.

In step S403, the CPU 101 generates answer sheet data. The processing proceeds to step S404. The answer sheet generation processing performed here is the same as that performed in step S401. Details of the answer sheet generation processing will be described below with reference to another flowchart.

In step S404, the CPU 101 makes the printer 106 print as many copies of the generated answer sheet data as the number of examinees plus one for filling out correct answers. The processing of this flowchart ends.

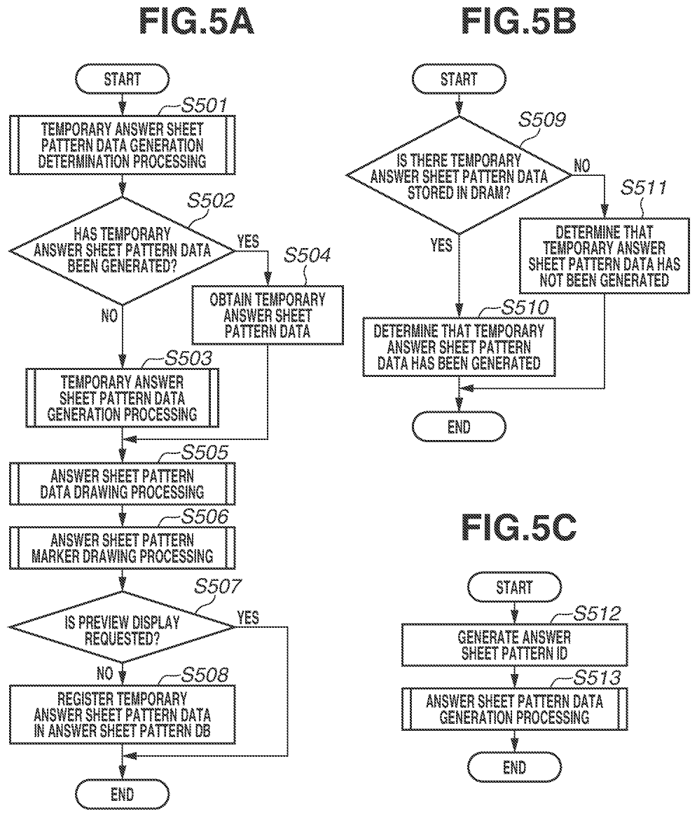

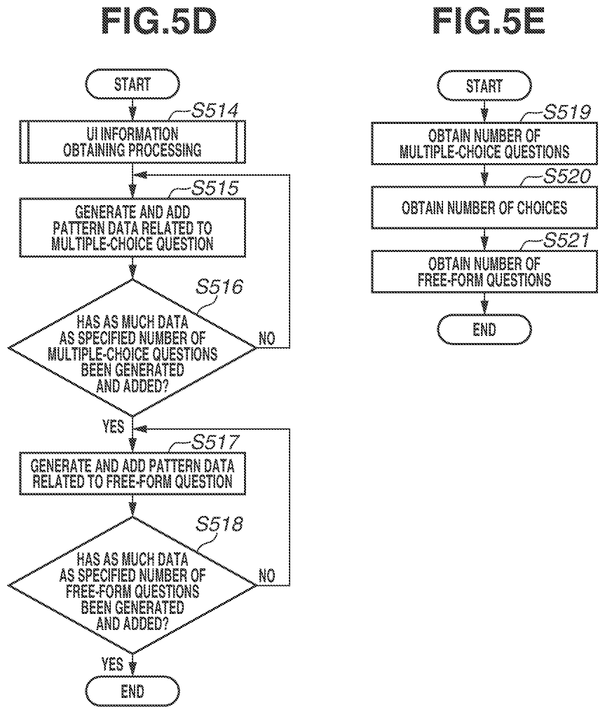

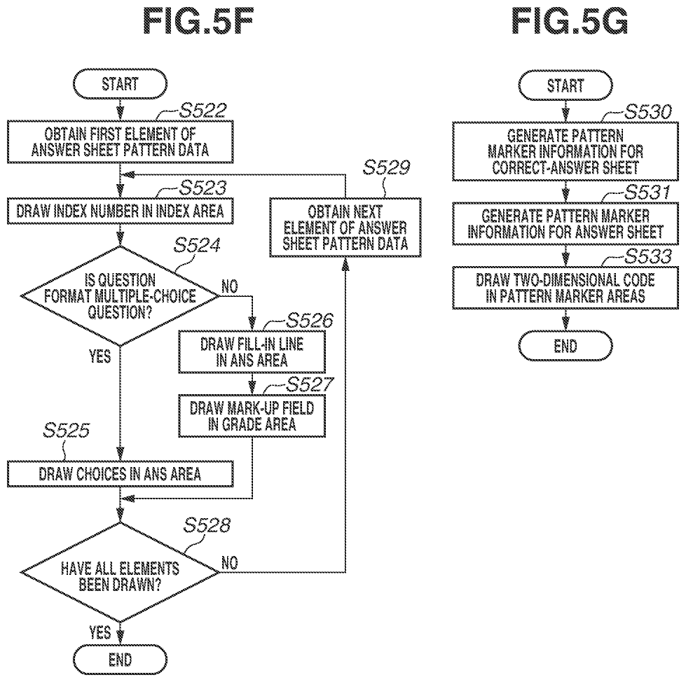

FIG. 5A is a flowchart of the answer sheet generation processing. The processing of this flowchart is performed by the CPU 101 reading a program stored in the ROM 102 into the DRAM 103 and running the program. Answer sheet pattern data constituting the answer sheet data is generated, an answer sheet pattern data image is generated, and the answer sheet pattern data is registered in the answer sheet pattern DB by the processing of this flowchart.

In step S501, the CPU 101 determines whether temporary answer sheet pattern data has been generated (temporary answer sheet pattern data generation determination processing). The processing proceeds to step S502. Details of the temporary answer sheet pattern data generation determination processing will be described below with reference to another flowchart.

In step S502, the CPU 101 determines whether temporary answer sheet pattern data has been generated based on the determination result obtained in step S501. If no temporary answer sheet pattern data has been generated (NO in step S502), the processing proceeds to step S503. If temporary answer sheet pattern data has been generated (YES in step S502), the processing proceeds to step S504.

In step S503, the CPU 101 generates temporary answer sheet pattern data (temporary answer sheet pattern data generation processing). The processing proceeds to step S505. Details of the temporary answer sheet pattern data generation processing will be described below with reference to another flowchart.

In step S504, the CPU 101 obtains the temporary answer sheet pattern data. The processing proceeds to step S505.

In step S505, the CPU 101 performs answer sheet pattern data drawing processing based on the temporary answer sheet pattern data. The processing proceeds to step S506. Details of the answer sheet pattern data drawing processing will be described below with reference to another flowchart.

In step S506, the CPU 101 performs answer sheet pattern marker drawing processing based on the temporary answer sheet pattern data. The processing proceeds to step S507. Details of the answer sheet pattern marker drawing processing will be described below with reference to another flowchart.

In step S507, the CPU 101 checks whether a preview display is requested by an execution instruction using the preview button in the answer sheet generation and print screen example 112. If a preview display is requested (YES in step S507), the processing of this flowchart ends. If a preview display is not requested (NO in step S507), the processing proceeds to step S508.

In step S508, the CPU 101 registers the temporary answer sheet pattern data in the answer sheet pattern DB. The processing of this flowchart ends.

FIG. 5B is a flowchart of the temporary answer sheet pattern data generation determination processing. The processing of this flowchart is performed by the CPU 101 reading a program stored in the ROM 102 into the DRAM 103 and running the program. Whether temporary answer sheet pattern data has been generated is determined by the processing of this flowchart.

In step S509, the CPU 101 checks whether there is temporary answer sheet pattern data stored in the DRAM 103. If there is temporary answer sheet pattern data stored in the DRAM 103 (YES in step S509), the processing proceeds to step S510. If not (NO in step S509), the processing proceeds to step S511.

In step S510, the CPU 101 determines that temporary answer sheet pattern data has been generated. The processing of this flowchart ends.

In step S511, the CPU 101 determines that temporary answer sheet pattern data has not been generated. The processing of this flowchart ends.

FIG. 5C is a flowchart of the temporary answer sheet pattern data generation processing. The processing of this flowchart is performed by the CPU 101 reading a program stored in the ROM 102 into the DRAM 103 and running the program. Temporary answer sheet pattern data is generated by the processing of this flowchart.

In step S512, the CPU 101 generates an answer sheet pattern ID. The processing proceeds to step S513. The answer sheet pattern ID generated here is a unique ID like a UUID.

In step S513, the CPU 101 performs answer sheet pattern data generation processing. The processing of this flowchart ends. The answer sheet pattern data generated here is stored in the DRAM 103 as temporary answer sheet pattern data.

FIG. 5D is a flowchart of the answer sheet pattern data generation processing. The processing of this flowchart is performed by the CPU 101 reading a program stored in the ROM 102 into the DRAM 103 and running the program. Answer sheet pattern data is generated by the processing of this flowchart.

In step S514, the CPU 101 obtains user interface (UI) information to be used in generating answer sheet pattern data (UI information obtaining processing). The processing proceeds to step S515. The UI information obtained here is set in the answer sheet generation and print screen example 112. Details of the UI information obtaining processing will be described below with reference to another flowchart.

In step S515, the CPU 101 generates and adds pattern data related to a multiple-choice question based on the obtained UI information. The processing proceeds to step S516. The pattern data generated here corresponds to the elements 307 to 309 illustrated in FIG. 3A.

In step S516, the CPU 101 checks whether as much data as the number of multiple-choice questions specified by the obtained UI information has been generated and added. If as much data has been generated and added (YES in step S516), the processing proceeds to step S517. If as much data has not been generated or added (NO in step S516), the processing proceeds to step S515 to generate the rest of the data.

In step S517, the CPU 101 generates and adds pattern data related to a free-form question based on the obtained UI information. The processing proceeds to step S518. The pattern data generated here corresponds to the elements 310 to 312 illustrated in FIG. 3A.

In step S518, the CPU 101 checks whether as much data as the number of free-form questions specified by the obtained UI information has been generated and added. If as much data has been generated and added (YES in step S518), the processing of this flowchart ends.

If as much data has not been generated or added (NO in step S518), the processing proceeds to step S517 to generate the rest of the data.

FIG. 5E is a flowchart of the UI information obtaining processing. The processing of this flowchart is performed by the CPU 101 reading a program stored in the ROM 102 into the DRAM 103 and running the program. UI information to be used in generating answer sheet pattern data is obtained by the processing of this flowchart.

In step S519, the CPU 101 obtains the number of multiple-choice questions set in the answer sheet generation and print screen example 112. The processing proceeds to step S520.

In step S520, the CPU 101 obtains the number of choices set in the answer sheet generation and print screen example 112. The processing proceeds to step S521.

In step S521, the CPU 101 obtains the number of free-form questions set in the answer sheet generation and print screen example 112. The processing of this flowchart ends.

While the foregoing procedure according to the first exemplary embodiment is described to obtain the three pieces of information to be used alone, other information is also obtained as appropriate if such information is used in other exemplary embodiments.

FIG. 5F is a flowchart of the answer sheet pattern data drawing processing. The processing of this flowchart is performed by the CPU 101 reading a program stored in the ROM 102 into the DRAM 103 and running the program. The areas of the respective questions stored in the answer sheet pattern data are drawn by the processing of this flowchart.

In step S522, the CPU 101 obtains the first element constituting the answer sheet pattern data. The processing proceeds to step S523.

In step S523, the CPU 101 draws the index number defined by the data on the target element (hereinafter, referred to as target element data) in the index area. The processing proceeds to step S524.

In step S524, the CPU 101 checks whether the question format defined in the target element data is a multiple-choice question. If the question format is a multiple-choice question (YES in step S524), the processing proceeds to step S525. If the question format is not a multiple-choice question (NO in step S524), the processing proceeds to step S526.

In step S525, the CPU 101 refers to the ans area information Aa defined in the target element data and the number of choices obtained from the UI information, and draws choices in the ans area. The processing proceeds to step S528.

In step S526, the CPU 101 refers to the ans area information Aa defined in the target element data, and draws a fill-in line in the ans area. The processing proceeds to step S527.

In step S527, the CPU 101 refers to the grade area information Ga defined in the target element data, and draws a mark-up field in the grade area. The processing proceeds to step S528.

In step S528, the CPU 101 checks whether all the elements of the answer sheet pattern data have been drawn. If all the elements have been drawn (YES in step S528), the processing of this flowchart ends. If all the elements have not been drawn (NO in step S528), the processing proceeds to step S529.

In step S529, the CPU 101 obtains the next element from the answer sheet pattern data. The processing proceeds to step S523.

By the foregoing processing, answer sheet data can be drawn as instructed by the user in FIGS. 1A and 1B.

FIG. 5G is a flowchart of the answer sheet pattern marker drawing processing. The processing of this flowchart is performed by the CPU 101 reading a program stored in the ROM 102 into the DRAM 103 and running the program. Pattern markers are attached to an answer sheet and a correct-answer sheet by the processing of this flowchart.

In step S530, the CPU 101 generates pattern marker information for a correct-answer sheet. The processing proceeds to step S531. The pattern marker information generated here corresponds to the example 304 of pattern marker information to be attached to a correct-answer sheet, illustrated in FIG. 3A.

In step S531, the CPU 101 generates pattern marker information for an answer sheet. The processing proceeds to step S533. The pattern marker information generated here corresponds to the example 305 of pattern marker information to be attached to an answer sheet, illustrated in FIG. 3A.

In step S533, the CPU 101 generates two-dimensional code data based on the pattern marker information, and draws two-dimensional codes in the pattern marker areas. The processing of this flowchart ends. As described above, the two-dimensional codes generated here may be any codes that can contain the pattern marker information. Examples include a QR code, Data Matrix, and MaxiCode.

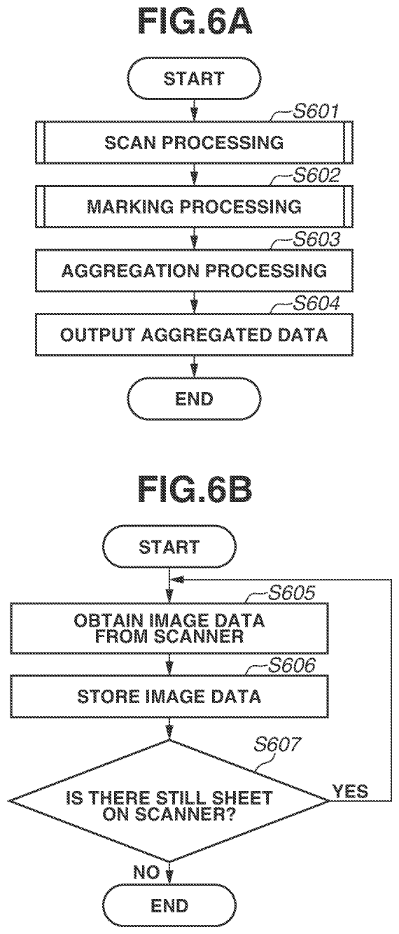

FIG. 6A is a flowchart of processing performed when the start button on the answer sheet marking and aggregation screen illustrated in FIG. 1B is pressed. The processing of this flowchart is performed by the CPU 101 reading a program stored in the ROM 102 into the DRAM 103 and running the program. Correct-answer and answer sheets are scanned, answers to the multiple-choice questions are marked based on the scanned image data, the marking results are aggregated, and the aggregated data is output by the processing of this flowchart.

In step S601, the CPU 101 makes the scanner 105 perform scan processing to obtain image data on correct-answer and answer sheets. The processing proceeds to step S602. Details of the scan processing will be described below with reference to another flowchart.

In step S602, the CPU 101 performs marking processing based on the obtained image data. The processing proceeds to step S603. Details of the marking processing will be described below with reference to another flowchart.

In step S603, the CPU 101 performs aggregation processing based on the marking results. The processing proceeds to step S604. This aggregation processing may include various types of general aggregation processing, such as ranking top scorers and aggregating the correct answer ratios of the respective questions.

In step S604, the CPU 101 outputs the generated aggregated data. The processing of this flowchart ends. The CPU 101 may output the aggregated data in various forms. For example, the aggregated data may be printed by the printer 106. The image processing unit 108 may convert the aggregated data into an image format, such as Joint Photographic Experts Group (JPEG) and Portable Document Format (PDF), and the communication unit 107 may transmit the converted data to outside as an e-mail or by File Transfer Protocol (FTP) transmission.

FIG. 6B is a flowchart of the scan processing. The processing of this flowchart is performed by the CPU 101 reading a program stored in the ROM 102 into the DRAM 103 and running the program. Image data is obtained from the scanner 105 and stored in the ROM 102 or the DRAM 103 by the processing of this flowchart.

In step S605, the CPU 101 obtains image data from the scanner 105. The processing proceeds to step S606.

In step S606, the CPU 101 stores the obtained image data in the ROM 102 or the DRAM 103. The processing proceeds to step S607.

In step S607, the CPU 101 checks whether there is still a sheet (document) on the scanner 105. If there is still a sheet (YES in step S607), the processing proceeds to step S605 to scan the sheet. If there is no sheet (NO in step S607), the processing of this flowchart ends.

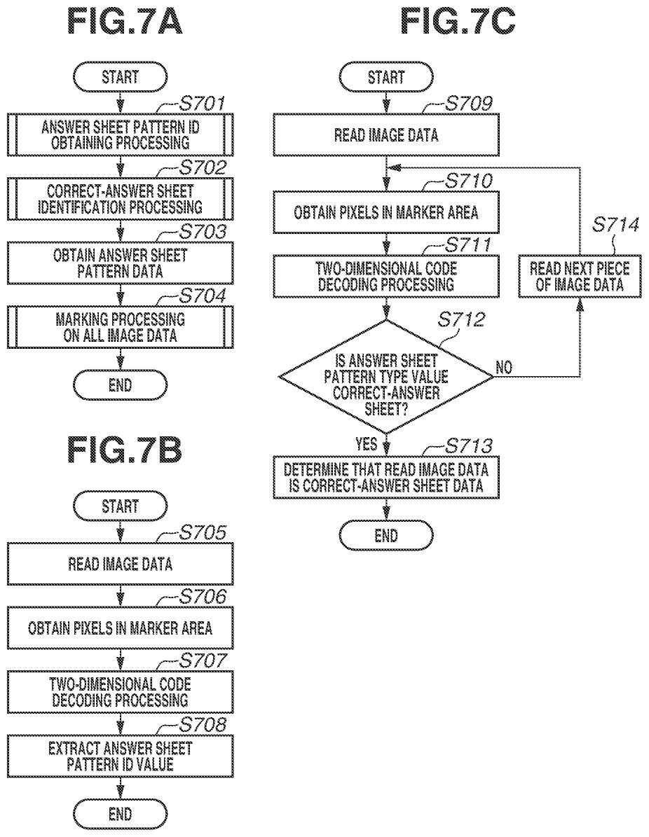

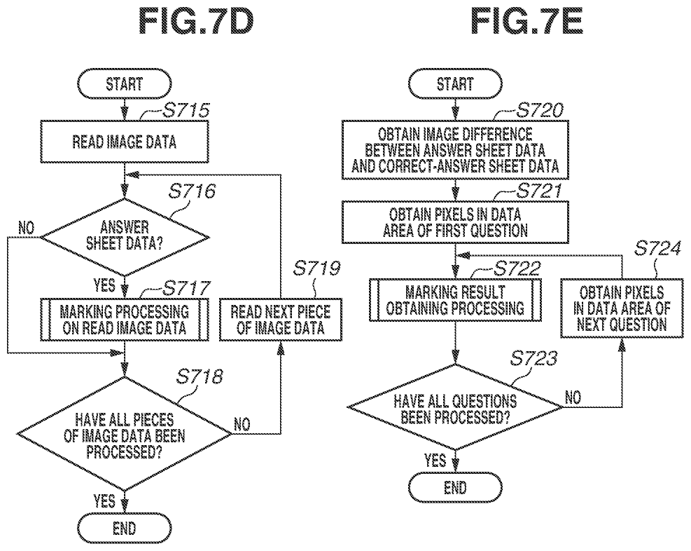

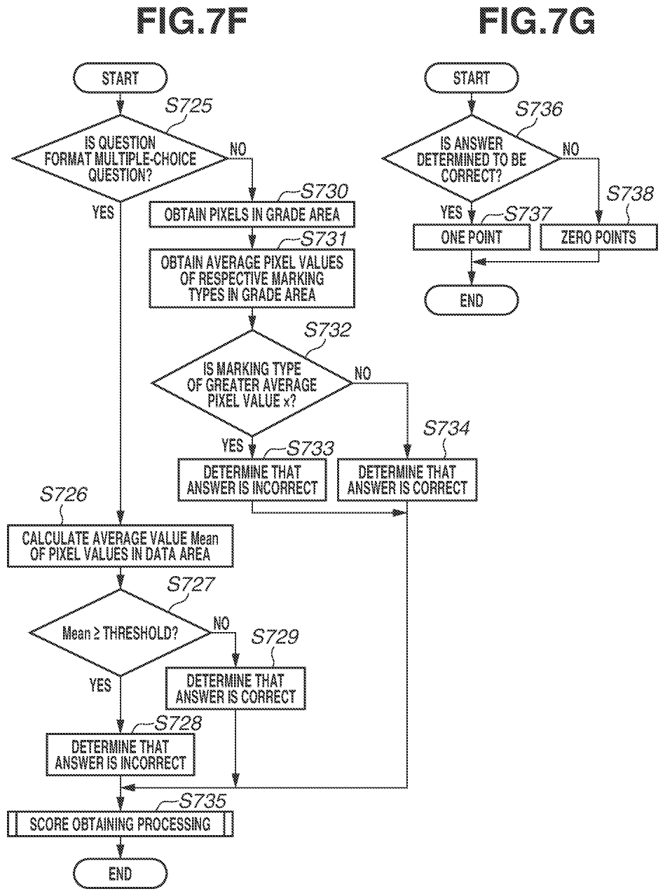

FIG. 7A is a flowchart of the marking processing. The processing of this flowchart is performed by the CPU 101 reading a program stored in the ROM 102 into the DRAM 103 and running the program. The marking processing is performed on the obtained answer sheets (image data) by the processing of this flowchart.

In step S701, the CPU 101 performs answer sheet pattern ID obtaining processing. The processing proceeds to step S702.

In step S702, the CPU 101 performs correction-answer sheet identification processing. The processing proceeds to step S703.

In step S703, the CPU 101 obtains answer sheet pattern data using the answer sheet pattern ID. The processing proceeds to step S704.

In step S704, the CPU 101 performs marking processing on all the image data using the obtained answer sheet pattern data. The processing of this flowchart ends.

FIG. 7B is a flowchart of the answer sheet pattern ID obtaining processing. The processing of this flowchart is performed by the CPU 101 reading a program stored in the ROM 102 into the DRAM 103 and running the program. An answer sheet pattern ID is obtained from image data by the processing of this flowchart.

In step S705, the CPU 101 reads image data from the ROM 102 or the DRAM 103. The processing proceeds to step S706.

In step S706, the CPU 101 obtains pixels in the marker area. The processing proceeds to step S707.

In step S707, the CPU 101 performs two-dimensional code decoding processing on the pixels in the marker area to obtain an analysis result. The processing proceeds to step S708. The two-dimensional code decoding processing performed here may be typical conventional decoding processing.

In step S708, the CPU 101 extracts an answer sheet pattern ID value from the obtained analysis result. The processing of this flowchart ends.

FIG. 7C is a flowchart of processing for identifying which piece of data in the obtained image data is correct-answer sheet data (correct-answer sheet identification processing). The processing of this flowchart is performed by the CPU 101 reading a program stored in the ROM 102 into the DRAM 103 and running the program. Correct-answer sheet data is identified from among the pieces of image data read in random order by the processing of this flowchart.

In step S709, the CPU 101 reads image data from the ROM 102 or the DRAM 103. The processing proceeds to step S710.

In step S710, the CPU 101 obtains pixels in the marker area. The processing proceeds to step S711.

In step S711, the CPU 101 performs two-dimensional code decoding processing on the pixels in the marker area to obtain an analysis result. The processing proceeds to step S712. The two-dimensional code decoding processing performed here may be typical conventional decoding processing.

In step S712, the CPU 101 extracts an answer sheet pattern type value from the obtained analysis result, and checks whether the answer sheet pattern type value is a correct-answer sheet. If the answer sheet pattern type value is a correct-answer sheet (YES in step S712), the processing proceeds to step S713.

If the answer sheet pattern type value is not a correct-answer sheet (NO in step S712), the processing proceeds to step S714.

In step S713, the CPU 101 determines that the read image data is correct-answer sheet data, and stores the image data in a temporary area, such as the DRAM 103. The processing of this flowchart ends.

In step S714, the CPU 101 reads the next piece of image data from the ROM 102 or the DRAM 103. The processing proceeds to step S710.

FIG. 7D is a flowchart for performing marking processing on all the image data obtained. The processing of this flowchart is performed by the CPU 101 reading a program stored in the ROM 102 into the DRAM 103 and running the program. The marking processing is performed on all the image data by the processing of this flowchart.

In step S715, the CPU 101 read image data from the ROM 102 or the DRAM 103. The processing proceeds to step S716.

In step S716, the CPU 101 checks whether the read image data is answer sheet data. If the read image data is answer sheet data (YES in step S716), the processing proceeds to step S717 to perform marking. If the read image data is not answer sheet data (NO in step S716), the processing proceeds to step S718.

In step S717, the CPU 101 performs marking processing on the read image data. The processing proceeds to step S718.

In step S718, the CPU 101 checks whether all the pieces of image data have been processed. If all the pieces of image data have been processed (YES in step S718), the processing of this flowchart ends. If there is image data yet to be processed (NO in step S718), the processing proceeds to step S719.

In step S719, the CPU 101 reads the next piece of image data from the ROM 102 or the DRAM 103. The processing proceeds to step S716.

FIG. 7E is a flowchart for performing the marking processing on obtained answer sheet data. The processing of this flowchart is performed by the CPU 101 reading a program stored in the ROM 102 into the DRAM 103 and running the program. The marking processing is performed on the answer sheet data by the processing of this flowchart.

In step S720, the CPU 101 obtains an image difference between the answer sheet data and the correct-answer sheet data identified in step S713 (image difference calculation processing). The processing proceeds to step S721. The image difference calculation processing performed here may be typical conventional processing, such as pixel value subtraction.

In step S721, the CPU 101 obtains data area information Da about the first question from the answer sheet pattern data obtained in step S703, and obtains pixels in the data area. The processing proceeds to step S722.

In step S722, the CPU 101 performs marking result obtaining processing on the pixels in the data area. The processing proceeds to step S723.

In step S723, the CPU 101 checks whether all the questions have been processed. If all the questions have been processed (YES in step S723), the processing of this flowchart ends. If there is a question yet to be processed (NO in step S723), the processing proceeds to step S724.

In step S724, the CPU 101 obtains data area information Da about the next question, and obtains pixels in the corresponding data area. The processing proceeds to step S722.

FIG. 7F is a flowchart of the marking result obtaining processing on pixels in a data area. The processing of this flowchart is performed by the CPU 101 reading a program stored in the ROM 102 into the DRAM 103 and running the program. The marking result of each question can be obtained by the processing of this flowchart.

In step S725, the CPU 101 checks whether the question format is a multiple-choice question. If the question format is a multiple-choice question (YES in step S725), the processing proceeds to step S726. If the question format is not a multiple-choice question (NO in step S725), the processing proceeds to step S730.

In step S726, the CPU 101 calculates an average value Mean of the pixel values in the data area. The processing proceeds to step S727. Here, the average value Mean can be calculated by using a typical conventional method, such as dividing an integrated pixel value by the area of the target area.

In step S727, the CPU 101 checks whether the average value Mean of the pixel values calculated in step S726 is greater than or equal to a predetermined threshold. If the average value Mean is greater than or equal to the threshold (YES in step S727), the processing proceeds to step S728. If the average value Mean is less than the threshold (NO in step S727), the processing proceeds to step S729.

If the choices on the correct-answer sheet and the answer sheet are filled exactly the same way, the image difference in the data area is zero. The average value Mean of the pixel values thus approaches zero, even with noise taken into account. By contrast, if different choices are filled, the average value Mean of the pixels is relatively large since the pixels of the filled choices of both the correct answer and incorrect answer remain in the obtained image difference. Whether the target choice is correct or incorrect can thus be determined by comparing the average value Mean with the threshold in step S727.

In step S728, the CPU 101 determines that the answer to the target question is incorrect. The processing proceeds to step S735.

In step S729, the CPU 101 determines that the answer to the target question is correct. The processing proceeds to step S735.

In step S730, the CPU 101 obtains pixels in the grade area. The processing proceeds to step S731.

In step S731, the CPU 101 obtains average pixel values of the respective marking types in the grade area. The processing proceeds to step S732. As with a multiple-choice question in step S727, if the choices are filled exactly the same way, the image difference is zero. If the choices are filled differently, the pixels of the filled portions remain as an image difference. In the grade area of a free-form question, the pixels of a filled portion always remain as an image difference. The marking type corresponding to the area of the greater average pixel value can thus be determined to be the marking result filled by the user (marker).

In step S732, the CPU 101 checks whether the marking type corresponding to the area of the greater average pixel value is x. If the marking type is x (YES in step S732), the processing proceeds to step S733. If the marking type is not x (NO in step S732), the processing proceeds to step S734.

In step S733, the CPU 101 determines that the answer to the target question is incorrect. The processing proceeds to step S735.

In step S734, the CPU 101 determines that the answer to the target question is correct. The processing proceeds to step S735.

In step S735, the CPU 101 obtains the score on the target question (score obtaining processing). The processing of this flowchart ends.

FIG. 7G is a flowchart of the score obtaining processing. The processing of this flowchart is performed by the CPU 101 reading a program stored in the ROM 102 into the DRAM 103 and running the program. The score on each question is obtained by the processing of this flowchart.

In step S736, the CPU 101 checks whether the answer to the question is determined to be correct. If the answer is determined to be correct (YES in step S736), the processing proceeds to step S737. If the answer is not determined to be correct (NO in step S736), the processing proceeds to step S738.

In step S737, the CPU 101 determines that the score is one point. The processing of this flowchart ends.

In step S738, the CPU 101 determines that the score is zero points. The processing of this flowchart ends.

As described above, the multifunction peripheral 100 can singly provide a system for generating and printing answer sheets and performing marking and aggregation.

In the first exemplary embodiment, the system for generating and printing answer sheets and performing marking and aggregation is described to be completed by the multifunction peripheral 100 alone. In a second exemplary embodiment, a system that performs a series of processes in cooperation with an external general education support system will be described in terms of differences in processing from the first exemplary embodiment. The second exemplary embodiment is different from the first exemplary embodiment in the source from which student-filled answer sheet data is obtained and the timing of drawing of grade areas on the answer sheet data. While this system cooperates with the external education support system, processing related to a login to and data acquisition from the education support system is irrelevant to the description of the present exemplary embodiment. The login and data acquisition therefore shall be performed by using typical conventional techniques, and the processing will not be mentioned in the present exemplary embodiment.

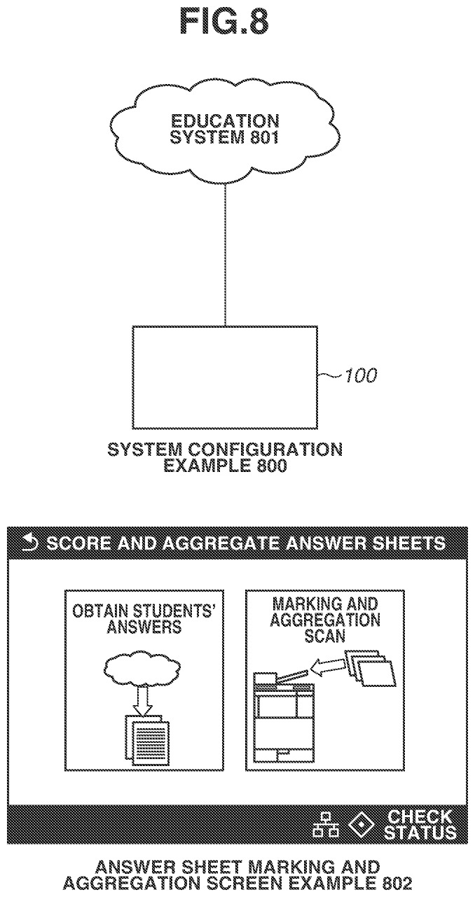

A system configuration example 800 in FIG. 8 illustrates a system configuration according to the second exemplary embodiment. A multifunction peripheral 100 and an external education system 801 are connected to each other via a communication unit 107. In this second exemplary embodiment, the multifunction peripheral 100 obtains student-filled answer sheet data from the external education system 801 and performs marking processing. The external education system 801 is not limited thereto. Google Classroom or OneDrive simply providing a storage function may be used.

An answer sheet marking and aggregation screen example 802 in FIG. 8 illustrates an example of an answer sheet marking and aggregation screen according to the second exemplary embodiment. Unlike the first exemplary embodiment, a button for obtaining students' answers from the external education system 801 and a marking and aggregation scan button for displaying the same answer sheet marking and aggregation screen example 114 as in the first exemplary embodiment are displayed.

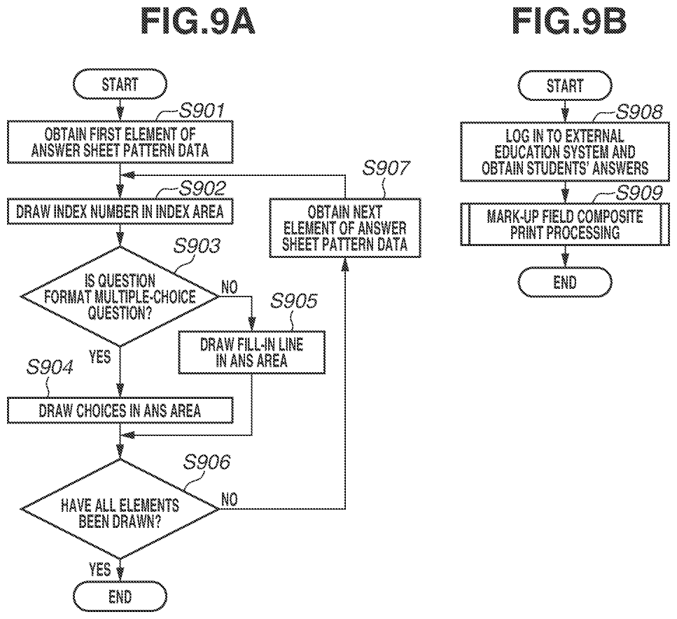

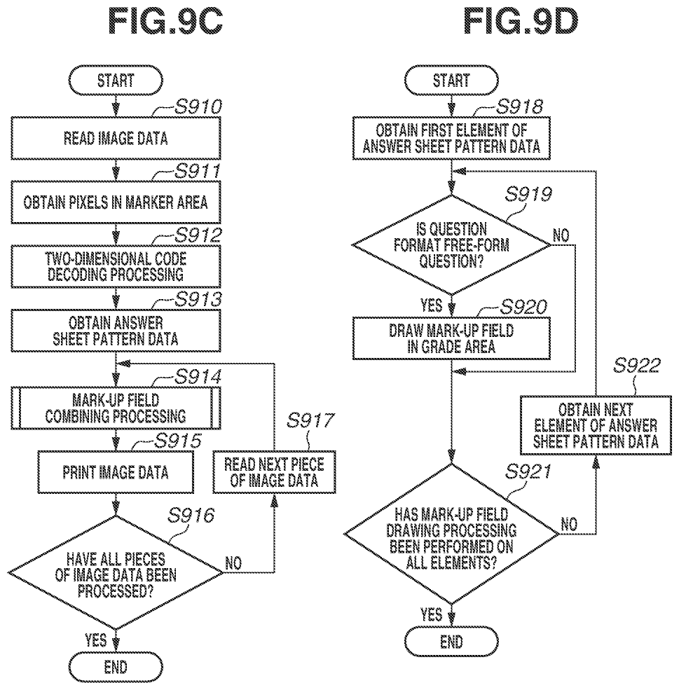

FIG. 9A is a flowchart of answer sheet data drawing processing according to the second exemplary embodiment. The processing of this flowchart is performed by a CPU 101 reading a program stored in a ROM 102 into a DRAM 103 and running the program. Answer sheet data is drawn by the processing of this flowchart.

In step S901, the CPU 101 obtains the first element of answer sheet pattern data. The processing proceeds to step S902.

In step S902, the CPU 101 refers to the element obtained in step S901, and draws the index number in the index area. The processing proceeds to step S903.

In step S903, the CPU 101 checks whether the question format of the element to be drawn is a multiple-choice question. If the question format is a multiple-choice question (YES in step S903), the processing proceeds to step S904. If the question format is not a multiple-choice question (NO in step S903), the processing proceeds to step S905.

In step S904, the CPU 101 draws choices in the ans area. The processing proceeds to step S906.

In step S905, the CPU 101 draws a line for a free-form question in the ans area. The processing proceeds to step S906.

In step S906, the CPU 101 checks whether the drawing processing has been completed of all the elements. If all the elements have been drawn (YES in step S906), the processing of this flowchart ends. If all the elements have not been drawn (NO in step S906), the processing proceeds to step S907.

In step S907, the CPU 101 obtains the next element from the answer sheet pattern data. The processing proceeds to step S902.

It can be seen that, unlike the first exemplary embodiment, the grade area including a mark-up field is not drawn at the timing when the answer sheet data is generated and printed.

FIG. 9B illustrates a flowchart of processing performed when the button for obtaining students' answers illustrated in FIG. 8 is pressed. The processing of this flowchart is performed by the CPU 101 reading a program stored in the ROM 102 into the DRAM 103 and running the program. Students' answers are obtained and printed for marking by the processing of this flowchart.

In step S908, the CPU 101 logs in to the external education system 801, obtains students' answers (hereinafter, referred to as answer data), and stores the obtained answer data in the ROM 102 or the DRAM 103. The processing proceeds to step S909. There are various methods for logging in to the external education system 801 and obtaining data. Since the methods here do not need to be limited, typical conventional methods are used.

In step S909, the CPU 101 combines the answer data obtained in step S908 with mark-up fields, and makes the printer 106 print the resulting data (mark-up field composite print processing). The processing of this flowchart ends.

This enables the multifunction peripheral 100 to perform marking and aggregation processing as in the first exemplary embodiment even if there are free-form questions.

FIG. 9C is a flowchart illustrating the mark-up field composite print processing on all the pieces of answer data. The processing of this flowchart is performed by the CPU 101 reading a program stored in the ROM 102 into the DRAM 103 and running the program. All the pieces of answer data are combined with mark-up fields and printed by the processing of this flowchart.

In step S910, the CPU 101 reads image data that is a piece of answer data from the ROM 102 or the DRAM 103. The processing proceeds to step S911.

In step S911, the CPU 101 obtains pixels in the marker area from the obtained image data. The processing proceeds to step S912.

In step S912, the CPU 101 performs two-dimensional code decoding processing on the obtained pixels in the marker area to obtain an answer sheet pattern ID. The processing proceeds to step S913.

In step S913, the CPU 101 obtains answer sheet pattern data using the obtained answer sheet pattern ID. The processing proceeds to step S914.

In step S914, the CPU 101 performs mark-up field combining processing on the image data using the obtained answer sheet pattern data. The processing proceeds to step S915.

In step S915, the CPU 101 makes the printer 106 print the image data with which the mark-up fields are combined. The processing proceeds to step S916.

In step S916, the CPU 101 checks whether all the pieces of image data have been processed.

If all the pieces of image data have been processed (YES in step S916), the processing of this flowchart ends. If there is image data yet to be processed (NO in step S916), the processing proceeds to step S917.

In step S917, the CPU 101 reads the next piece of image data from the ROM 102 or the DRAM 103. The processing proceeds to step S914.

FIG. 9D is a flowchart illustrating processing for performing the mark-up field combining processing on a piece of image data. The processing of this flowchart is performed by the CPU 101 reading a program stored in the ROM 102 into the DRAM 103 and running the program. A piece of image data is combined with mark-up fields by the processing of this flowchart.

In step S918, the CPU 101 obtains the first element of the answer sheet pattern data. The processing proceeds to step S919.

In step S919, the CPU 101 checks whether the question format of the processing target is a free-form question. If the question format is a free-form question (YES in step S919), the processing proceeds to step S920. If the question format is not a free-form question (NO in step S919), the processing proceeds to step S921 since a mark-up field does not need to be combined.

In step S920, the CPU 101 draws a mark-up field in the grade area. The processing proceeds to step S921.

In step S921, the CPU 101 checks whether the mark-up field drawing processing has been performed on all the elements. If the mark-up field drawing processing has been performed on all the elements (YES in step S921), the processing of this flowchart ends. If there is an element yet to be processed (NO in step S921), the processing proceeds to step S922.

In step S922, the CPU 101 obtains the next element from the answer sheet pattern data. The processing proceeds to step S919.

By the foregoing processing, all the free-form questions in the answer image data can be combined with mark-up fields.

As described above, if the multifunction peripheral 100 and the external education system 801 are cooperating, answer sheet data is generated without combining mark-up fields. The image data obtained from the education system 801 is then combined with mark-up fields and printed. A system that generates and prints answer sheets and performs marking and aggregation in a similar manner to the first exemplary embodiment can thereby be provided.

In the first and second exemplary embodiments, the system is described to allocate the same points to all the multiple-choice questions and free-form questions. However, free-form questions are often given different points depending on their difficulty level. A third exemplary embodiment thus deals with a system where, unlike the first and second exemplary embodiments, different points are allocated question by question. Only differences of the third exemplary embodiment from the first and second exemplary embodiments will be described.

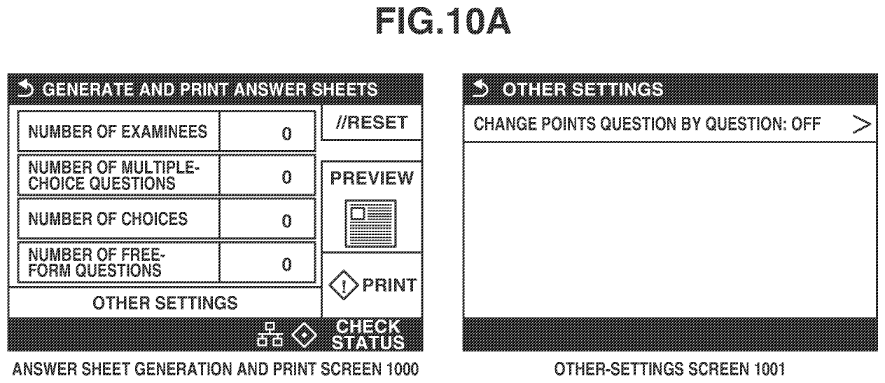

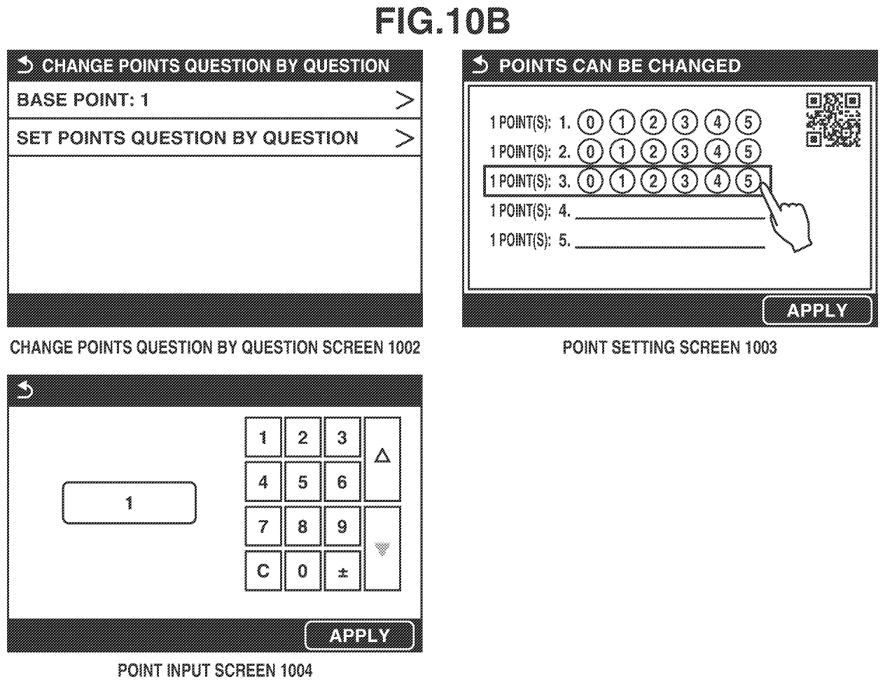

FIGS. 10A and 10B illustrate examples 1000 to 1004 of a series of screens related to the generation and printing of answer sheets according to the third exemplary embodiment.

An answer sheet generation and print screen 1000 illustrates a screen for generating and printing answer sheets according to the third exemplary embodiment. Unlike the answer sheet generation and print screen example 112 displayed in the first and second exemplary embodiments, an other-settings button for marking point settings is added to the answer sheet generation and print screen 1000.

An other-settings screen 1001 is a screen displayed if the other-settings button displayed on the answer sheet generation and print screen 1000 is pressed. Since the third exemplary embodiment is intended to change points question by question, a menu to change points question by question is displayed.

A change points question by question screen 1002 is a screen displayed if the “change points question by question button” displayed on the other-settings screen 1001 is pressed. The change points question by question screen 1002 displays two items, one related to a base point and the other for setting points question by question. If the “base point” button is pressed to set points, the points of all the questions are changed to the same value. If the “set points question by question” button is pressed and the point of a specific question is set, the point of that question is changed.

A point setting screen 1003 is a screen displayed when the “set points question by question” button is pressed on the change points question by question screen 1002. The point setting screen 1003 is similar to the answer sheet preview screen example 113 in appearance, and a specific question can be selected by tapping on the operation unit 104.

A point input screen 1004 is a screen displayed if the “base point” button is pressed on the change points question by question screen 1002 or if a specific question is selected on the point setting screen 1003. A change can be applied by inputting points using the numerical keypad on the point input screen 1004 and pressing an “apply” button.

Such a configuration enables both uniform and question-by-question changes of point allocation.

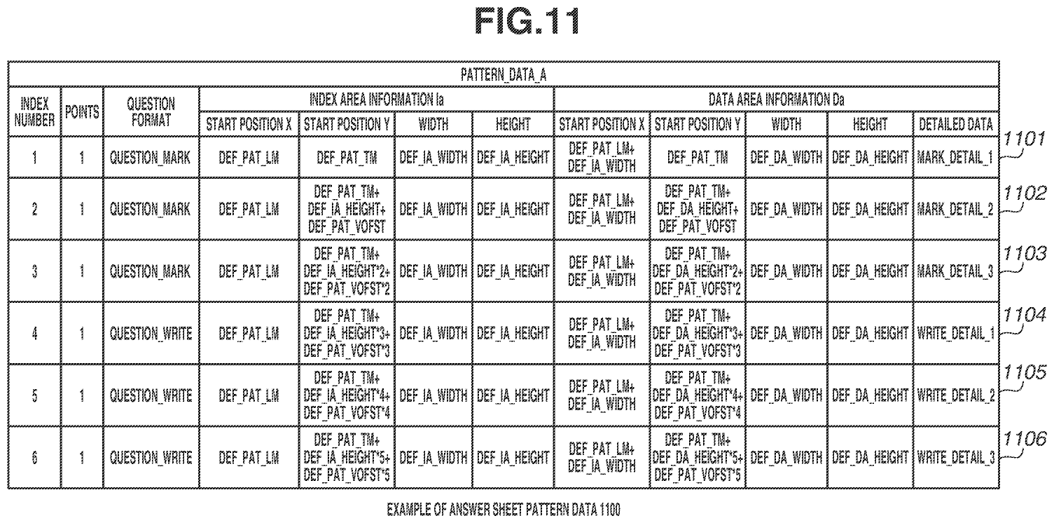

FIG. 11 illustrates an example 1100 of answer sheet pattern data according to the third exemplary embodiment. Elements 1101 to 1106 are basically similar to those (307 to 312) according to the first and second exemplary embodiments. The difference is that point information to be described in this third exemplary embodiment is added to each element. The provision of point information for each question enables the proposed system to perform marking even if different points are allocated question by question.

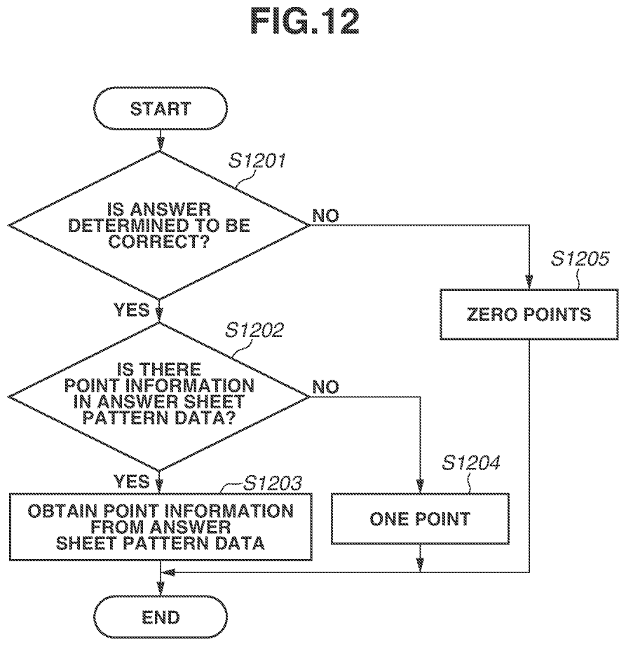

FIG. 12 is a flowchart for obtaining the score on each question according to the third exemplary embodiment. The processing of this flowchart is performed by a CPU 101 reading a program stored in a ROM 102 into a DRAM 103 and running the program. The score on each question is obtained by the processing of this flowchart.

In step S1201, the CPU 101 checks whether the answer to the question is determined to be correct. If the answer is determined to be correct (YES in step S1201), the processing proceeds to step S1202. If the answer is not determined to be correct (NO in step S1201), the processing proceeds to step S1205.

In step S1202, the CPU 101 checks the answer sheet pattern data for point information. If there is point information (YES in step S1202), the processing proceeds to step S1203. If there is no point information (NO in step S1202), the processing proceeds to step S1204.

In step S1203, the CPU 101 obtains points from the point information about this element of the answer sheet pattern data. The processing of this flowchart ends.

In step S1204, the CPU 101 determines that the score is one point. The processing of this flowchart ends.

In step S1205, the CPU 101 determines that the score is zero points. The processing of this flowchart ends.

As described above, a system can be provided that generates and prints answer sheets with different points allocated question by question and performs marking and aggregation.

In the third exemplary embodiment, a system for handling the case where different points are allocated question by question has been described.

However, as a method for point allocation, point information may be obtained from answer sheets instead of providing the answer sheet pattern data with the point information. In a fourth exemplary embodiment, a system that obtains point information from answer sheets will be described. Again, differences between the fourth exemplary embodiment and the foregoing exemplary embodiments will be described.

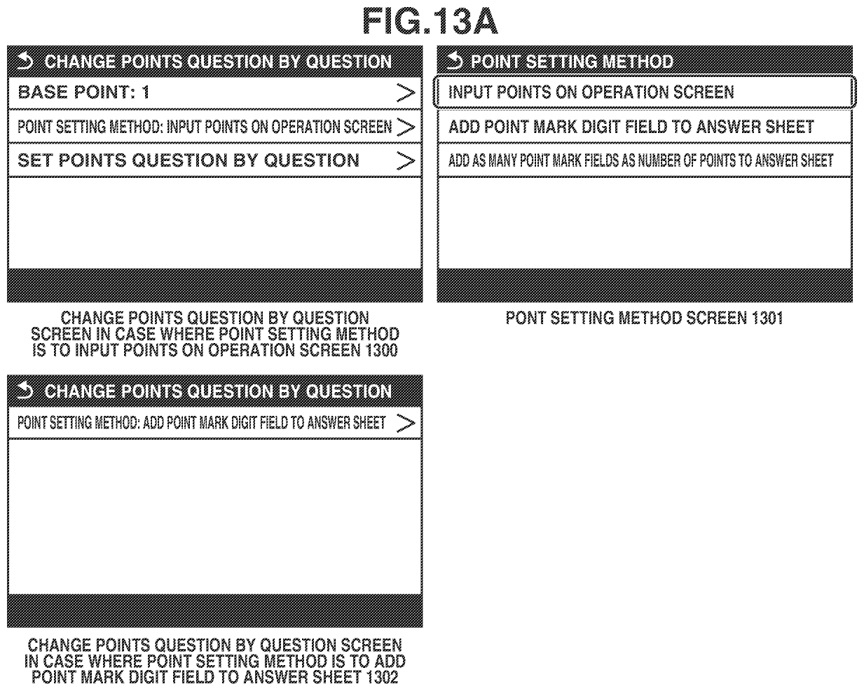

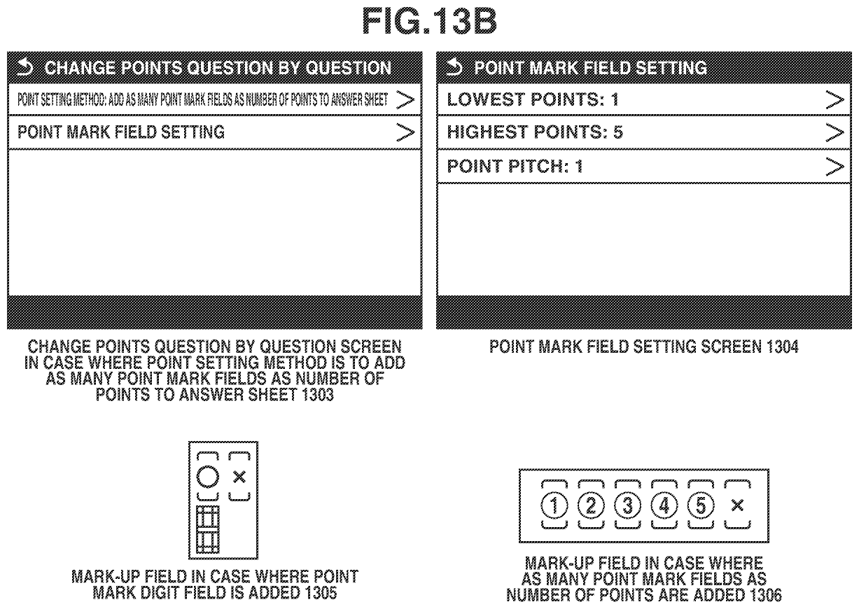

FIGS. 13A and 13B illustrate examples 1300 to 1304 of a series of screens related to point setting according to the present exemplary embodiment and examples 1305 and 1306 of mark-up fields attached to an answer sheet.

A change points question by question screen 1300 in the point setting method for inputting points from the operation screen is a change points question by question screen displayed in an initial state in the fourth exemplary embodiment. The initial value in the point setting method is set at “input points from the operation screen”, which corresponds to the case discussed in the third exemplary embodiment. The change points question by question screen 1300 displays the following three items: an item to set a base point and an item to set points question by question like the change points question by question screen 1002 illustrated in FIG. 10B; and an item to select the point setting method used in the fourth exemplary embodiment. In the case of setting a base point and in the case of setting points question by question, similar processing to that of the third exemplary embodiment is performed.

A point setting method screen 1301 is a screen displayed to select a method for obtaining points. Inputting points on the operation screen refers to the point setting method according to the third exemplary embodiment. Adding a point mark digit field to the answer sheet and adding as many point mark fields as the number of points to the answer sheet refer to point setting methods proposed in this fourth exemplary embodiment.

A change points question by question screen 1302 in the point setting method for adding a point mark digit field to the answer sheet illustrates a screen displayed if the choice to add a point mark digit field to the answer sheet is selected on the point setting method screen 1301. In the case of this setting method, there is no item to be input on the operation screen since point information is obtained from point mark digit fields added to the answer sheet. Items such as a basic point are therefore not displayed.

A change points question by question screen 1303 in the point setting method for adding as many point mark fields as the number of points to the answer sheet illustrates a screen displayed if the choice to add as many point mark fields as the number of points to the answer sheet is selected on the point setting method screen 1301. In such a case, there is a point mark field setting item to set how many points to add point mark fields.

A point mark field setting screen 1304 is a screen for setting how many points to add point mark fields if as many point mark fields as the number of points are to be added to the answer sheet. The lowest points, the highest points, and a pitch of how many points to generate mark fields at can be specified.

A mark-up field 1305 in the case where a point mark digit field is added is an example of the mark-up field to be drawn in the grade area of the answer sheet if the choice to add a point mark digit field to the answer sheet is selected. A mark digit field is added to the conventional mark fields ∘ and x. In such a case, the points to the question can be determined by filling in a digit of 0 to 9.

A mark-up field 1306 in the case where as many point mark fields as the number of points are added is an example of the mark-up field drawn in the grade field of the answer sheet if the choice to add as many point mark fields as the number of points to the answer sheet is selected. As many point-allocated ∘ mark fields as the number of points set on the point mark field setting screen 1304 are added to the conventional x mark field. Here, the points to a correct answer to the question can be determined by filling out an appropriate point-allocated ∘ mark field.

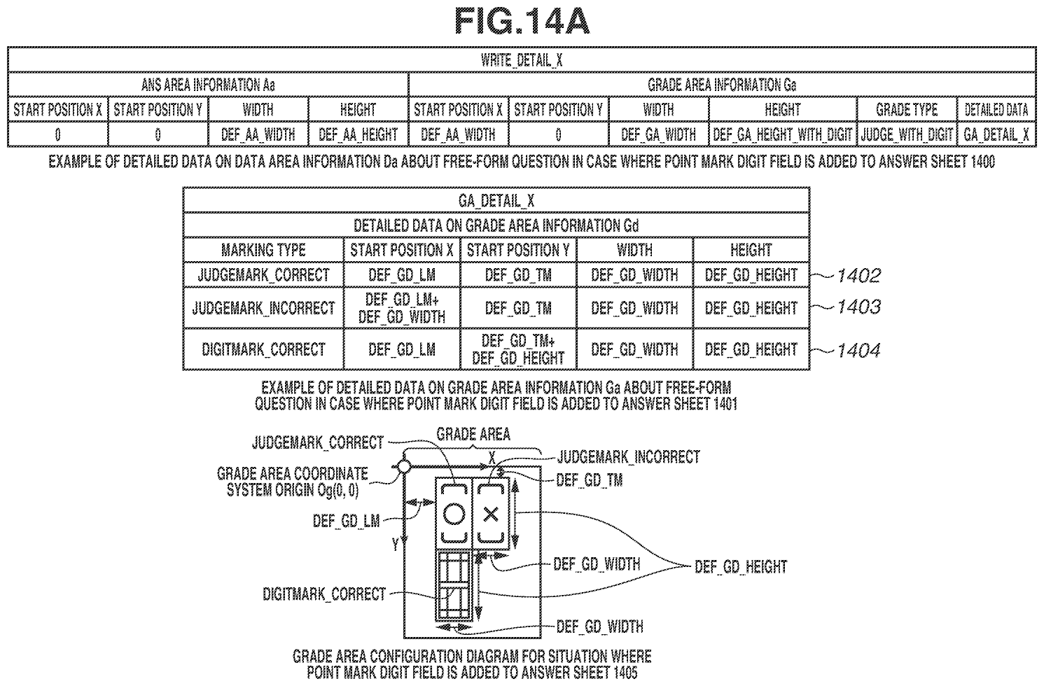

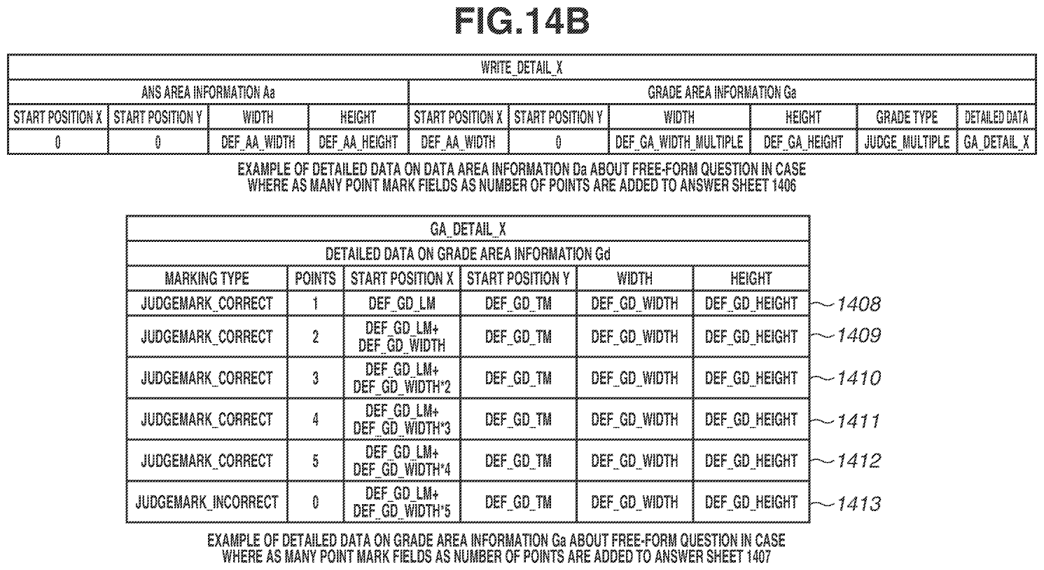

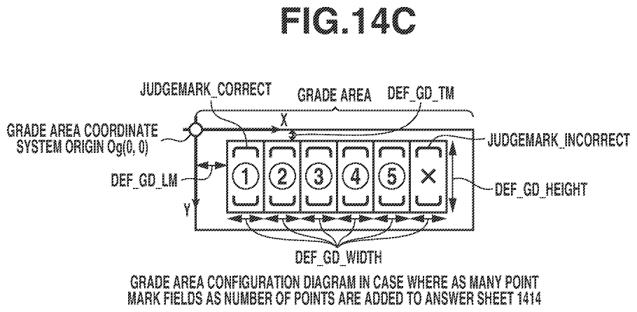

Now, an example 1404 of detailed data on data area information Da, an example 1401 of detailed data on grade area information Ga, and a grade area configuration diagram 1405 in FIGS. 14A-B will be described. These examples and diagram illustrate answer sheet pattern data to be generated if the choice to add a point mark digit field to the answer sheet is selected on the point setting method screen 1301 of FIG. 13A. Each item will be described below.

The example 1400 of detailed data on the data area information Da of the answer sheet pattern data includes basically the same information as that of the example 314 of detailed data on the data area information Da about a free-form question in FIG. 3B, described in the first exemplary embodiment. Differences are that the height in the grade area information Ga is changed to DEF_GA_HEIGHT_WITH_DIGIT in consideration of the point mark digit field, and that an item called grade type is added to the grade area information Ga. The grade type includes type information JUDGE_WITH_DIGIT indicating the addition of the point mark digit field. A CPU 101 can select marking processing intended for this method by referring to this item.

The example 1401 of detailed data on the grade area information Ga about a free-form question includes basically the same information as that of the example 315 of detailed data on the grade area information Ga in FIG. 3B, described in the first exemplary embodiment.

Specifically, like the element 316, an element 1402 contains information about a JUDGEMARK_CORRECT area indicating a correct answer ∘. Like the element 317, an element 1403 contains information about a JUDGEMARK_INCORRECT area indicating an incorrect answer x. The difference is in an element 1404, which contains information about a DIGITMARK_CORRECT area that is a digit mark area to include point information about a correct answer ∘. In obtaining points to the correct answer during marking, the CPU 101 can obtain the points by performing image processing on the DIGITMARK_CORRECT area defined by the element 1404.

The grade area configuration diagram 1405 has basically the same configuration as that of the grade area configuration diagram 213 in FIG. 2B, described in the first exemplary embodiment. A difference is that DIGITMARK_CORRECT added by the element 1404 is drawn. As defined by the element 1404, DIGITMARK_CORRECT is drawn under JUDGEMARK_CORRECT.

An example 1406 of detailed data on data area information Da, an example 1407 of detailed data on grade area information Ga, and a grade area configuration diagram 1414 in FIGS. 14A to 14C will be described. These examples and diagram illustrate answer sheet pattern data to be generated if the choice to add as many point mark fields as the number of points to the answer sheet is selected on the point setting method screen 1301 illustrated in FIG. 13A. Each item will be described below.

The example 1406 of detailed data on the data area information Da of the answer sheet pattern data includes basically the same information as that of the example 314 of detailed data on the data area information Da about a free-form question in FIGS. 3A-B, described in the first exemplary embodiment. Differences are that the width in the grade area information Ga is changed to DEF_GA_WIDTH_MULTIPLE in consideration of the addition of as many point mark fields as the number of points, and that an item called grade type is added to the grade area information Ga. The grade type includes type information JUDGE_MULTIPLE indicating the addition of as many point mark fields as the number of points. The CPU 101 can select marking processing intended for this method by referring to this item.

The example 1407 of detailed data on the grade area information Ga includes basically the same information as that of the example 315 of detailed data on the grade area information Ga about a free-form question in FIG. 3B, described in the first exemplary embodiment.

Specifically, like the element 316, elements 1408 to 1412 contain information about a JUDGEMARK_CORRECT area indicating a correct answer ∘. Differences are in the X coordinate of the start position due to the provision of as many JUDGEMARK_CORRECT areas as the number of points, and in that an item related to point information is added. Since the point information is set with respect to each of the elements 1408 to 1412, the CPU 101 can identify the score by obtaining the point information about the element corresponding to the selected area.

Like the element 317, an element 1413 contains information about a JUDGEMARK_INCORRECT area indicating an incorrect answer x. Again, differences are in the X coordinate of the start position and in that point information is added. Since the answer is incorrect, zero points are set here.

The grade area configuration diagram 1414 has basically the same configuration as that of the grade area configuration diagram 213 in FIG. 2B, described in the first exemplary embodiment. A difference is that the points set in the elements 1408 to 1412 are displayed in the JUDGEMARK_CORRECT areas defined by the respective elements 1408 to 1412 along with ∘ representing a correct answer.

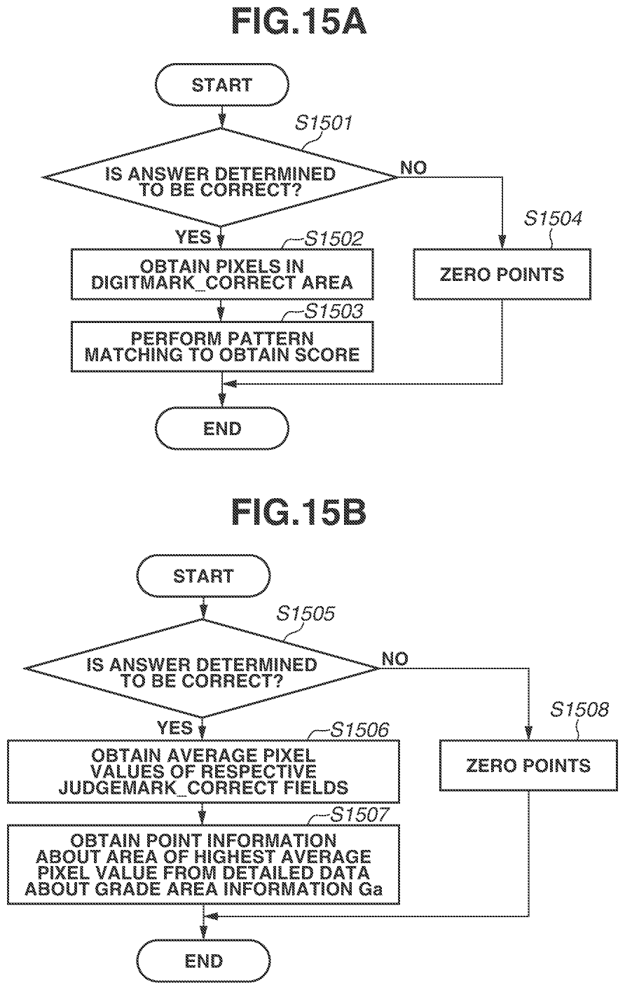

FIG. 15A is a flowchart of score obtaining processing to be performed if the choice to add a point mark digit field to the answer sheet is selected on the point setting method screen 1301 illustrated in FIG. 13A. The processing of this flowchart is performed by the CPU 101 reading a program stored in a ROM 102 into a DRAM 103 and running the program. A score is obtained from the point mark digit field by the processing of this flowchart.

In step S1501, the CPU 101 checks whether the answer to the target question is determined to be correct. If the answer is determined to be correct (YES in step S1501), the processing proceeds to step S1502. If the answer is not determined to be correct (NO in step S1501), the processing proceeds to step S1504.

In step S1502, the CPU 101 obtains pixels in the DIGITMARK_CORRECT area. The processing proceeds to step S1503.

In step S1503, the CPU 101 performs pattern matching on the obtained pixels to obtain the score. The processing of this flowchart ends. The pattern matching performed in this processing may be typical conventional matching processing. Examples include using the sum of squares of differences in pixel value, and using the sum of absolute values of differences in pixel value.

In step S1504, the CPU 101 determines that the score is zero points. The processing of this flowchart ends.

FIG. 15B is a flowchart of score obtaining processing to be performed if the choice to add as many point mark fields as the number of points to the answer sheet is selected on the point setting method screen 1301 illustrated in FIG. 13A. The processing of this flowchart is performed by the CPU 101 reading a program stored in the ROM 102 into the DRAM 103 and running the program. A score corresponding to the user-selected point mark field is obtained by the processing of this flowchart.

In step S1505, the CPU 101 checks whether the answer to the target question is determined to be correct. If the answer is determined to be correct (YES in step S1505), the processing proceeds to step S1506. If the answer is not determined to be correct (NO in step S1505), the processing proceeds to step S1508.

In step S1506, the CPU 101 obtains the average pixel values of the respective JUDGEMARK_CORRECT areas. The processing proceeds to step S1507. The average pixel value obtaining processing performed here may use a typical conventional means, such as dividing an integrated pixel value by the area.

In step S1507, the CPU 101 obtains point information about the area of the highest average pixel value from the detailed data on the grade area information Ga. The processing of this flowchart ends.

In step S1508, the CPU 101 determines that the score is zero points. The processing of this flowchart ends.

As described above, a system can be provided that generates and prints answer sheets from which, if different points are allocated question by question, the points can be identified by obtaining point mark information drawn on the answer sheets aside from inputting the points on the operation screen, and performs marking and aggregation.

In the first to fourth exemplary embodiments, a system has been described that handles the case where possible marking types are ∘ representing a correct answer and x representing an incorrect answer. However, in the case of free-form questions, a marking type Δ representing a partially correct answer can be used to give partial marks. In a fifth exemplary embodiment, a system capable of handling ∘ representing a correct answer, x representing an incorrect answer, and Δ representing a partially correct answer will be described. Again, differences between the fifth exemplary embodiment and the foregoing exemplary embodiments will be described.

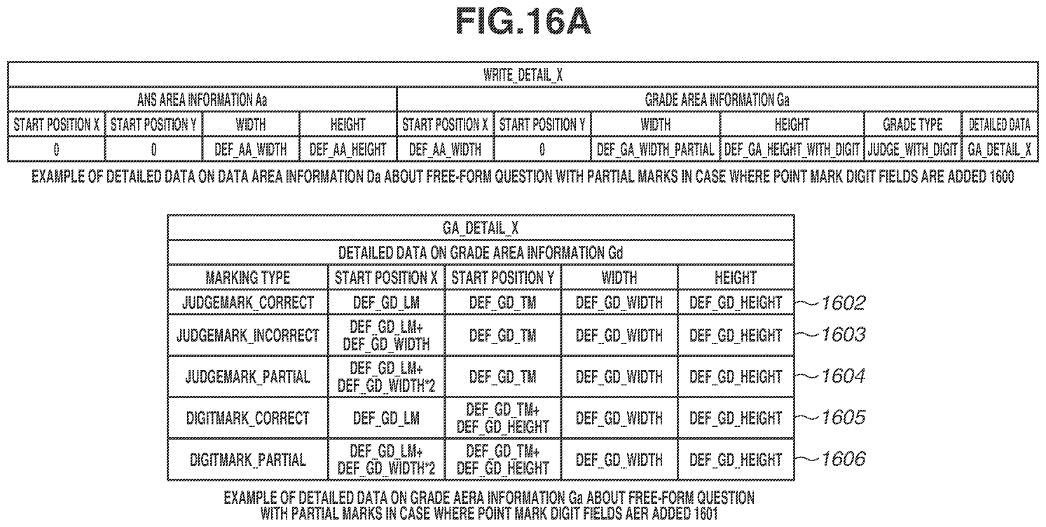

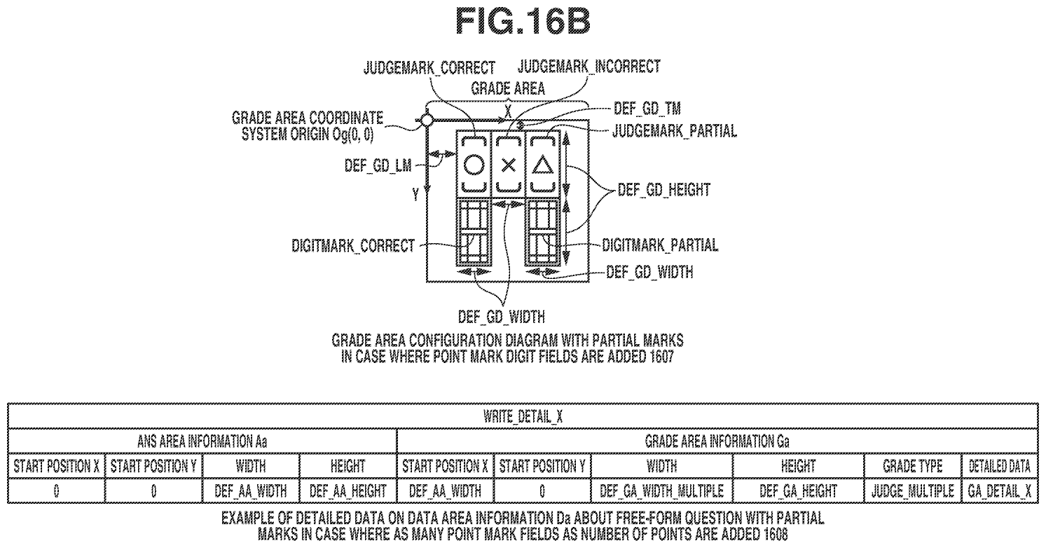

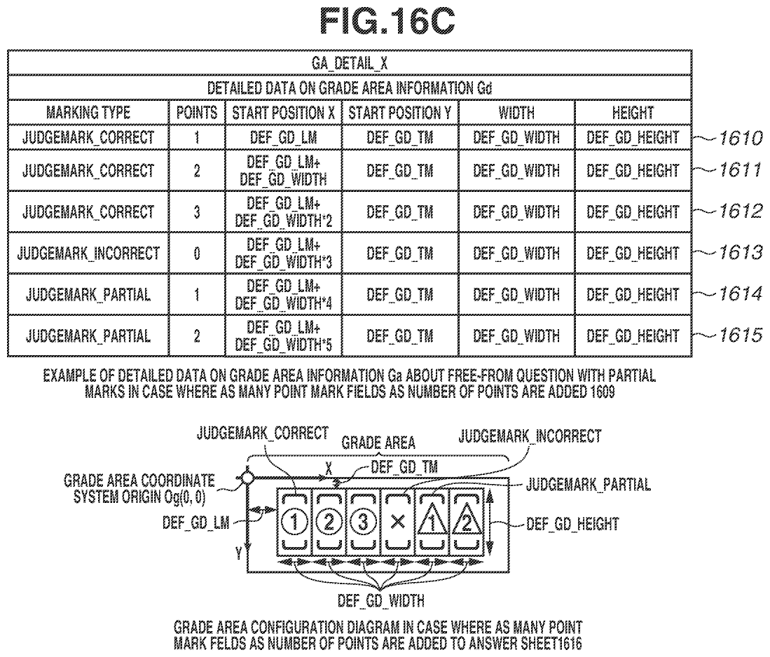

An example 1600 of detailed data on data area information Da, an example 1601 of detailed data on grade area information Ga, and a grade area configuration diagram 1607 in FIGS. 16A to 16C will be described. These examples and diagram illustrate answer sheet pattern data to be generated if the choice to add a point mark digit field to the answer sheet is selected on the point setting method screen 1301 of FIG. 13A. Each item will be described below.

The example 1600 of detailed data on the data area information Da of the answer sheet pattern data includes basically the same information as that of the example 1400 of detailed data on the data area information Da in FIG. 14A, described in the fourth exemplary embodiment. A difference is that the width in the grade area information Ga is changed to DEF_GA_WIDTH_PARTIAL in consideration of the drawing of a point mark digit field for a partially correct answer.

Elements 1602 to 1606 contain basically the same information as that of the elements 1402 to 1404 in FIG. 14A, described in the fourth exemplary embodiment.

Specifically, like the element 1402, the element 1602 contains information about a JUDGEMARK_CORRECT area indicating a correct answer ∘. Like the element 1403, the element 1603 contains information about a JUDGEMARK_INCORRECT area indicating an incorrect answer x. Like the element 1404, the element 1605 contains information about a DIGITMARK_CORRECT area that is a digit mark area to include point information about a correct answer ∘.

A difference is that the elements 1604 and 1606 are added.

The element 1604 contains information about a JUDGEMARK_PARTIAL area indicating a partially correct answer Δ. The JUDGEMARK_PARTIAL area is defined to be drawn next to the JUDGEMARK_INCORRECT area.

The element 1606 contains information about a DIGITMARK_PARTIAL area that is a digit mark area to include point information about a partially correct answer Δ. The DIGITMARK_PARTIAL area is defined to be drawn directly below the JUDGEMARK_PARTIAL area. In obtaining points to a partially correct answer during marking, a CPU 101 can obtain the points by performing image processing on the DIGITMARK_PARTIAL area defined by the element 1606.

The grade area configuration diagram 1607 has basically the same configuration as that of the grade area configuration diagram 1405 in FIG. 14A, described in the fourth exemplary embodiment. A difference is that the JUDGEMARK_PARTIAL area and the DIGITMARK_PARTIAL area added by the elements 1604 and 1606 are drawn.

An example 1608 of detailed data on data area information Da, an example 1609 of detailed data on grade area information Ga, and a grade area configuration diagram 1616 in FIGS. 16B and 16C will be described. These examples and diagram illustrate answer sheet pattern data to be generated if the choice to add as many point mark fields as the number of points to the answer sheet is selected on the point setting method screen 1301 illustrated in FIG. 13A. The present exemplary embodiment deals with an example where the lowest points are set one point, the highest points three points, and the point pitch one.

The example 1608 of detailed data on the data area information Da of the answer sheet pattern data includes basically the same information as that of the example 1406 of detailed data on the data area Information Da in FIGS. 14A-B, described in the fourth exemplary embodiment. If the number of point mark fields to be added is changed, the width in the grade area information Ga is changed based on the change.

The example 1609 of detailed data on grade area information Ga contains basically the same information as that of the example 1407 of detailed data on the grade area information Ga about a free-form question in FIG. 14B, described in the fourth exemplary embodiment.

Specifically, like the elements 1408 to 1412, elements 1610 to 1612 contain information about a JUDGEMARK_CORRECT area indicating a correct answer ∘ and points. Like the element 1413, an element 1613 contains information about a JUDGEMARK_INCORRECT area indicating an incorrect answer x.

A difference is in the addition of elements 1614 and 1615 that are information about a JUDGEMARK_PARTIAL area indicating a partially correct answer Δ and points. The element 1614 corresponds to a case where the points is one point. The element 1615 corresponds to a case where the points are two points. There is no partially correct answer element corresponding to three points since the highest points, three, means a correct answer ∘.

The grade area configuration diagram 1616 has basically the same configuration as that of the grade area configuration diagram 1414 in FIG. 14C, described in the fourth exemplary embodiment. A difference is that the points set in the elements 1614 and 1615 are displayed in the JUDGEMARK_PARTIAL areas defined by the respective elements 1614 and 1615 along with Δ representing a partially correct answer.

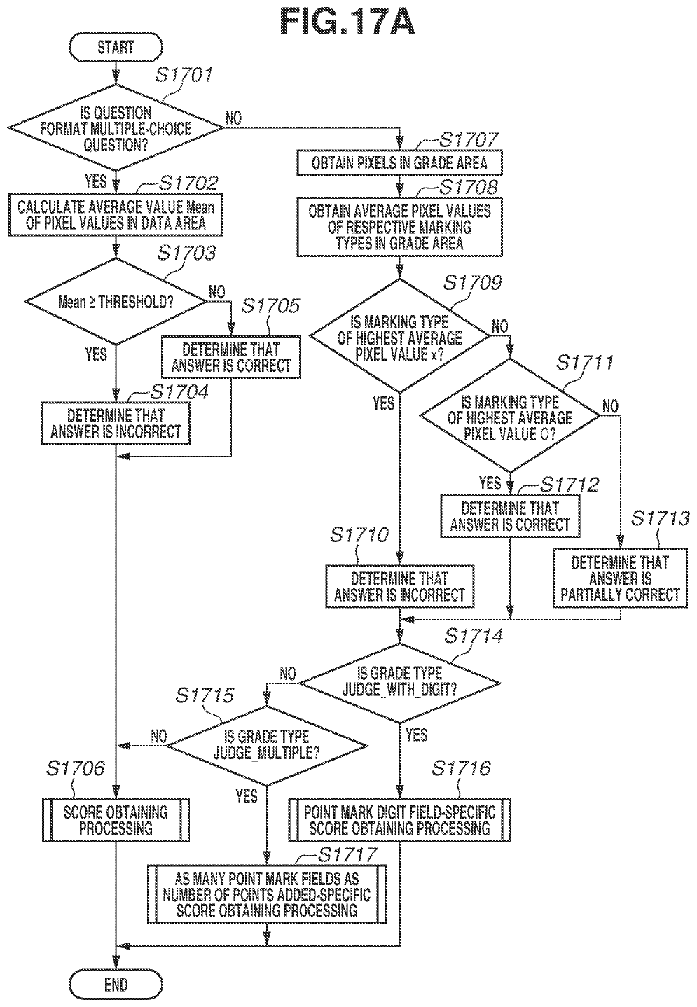

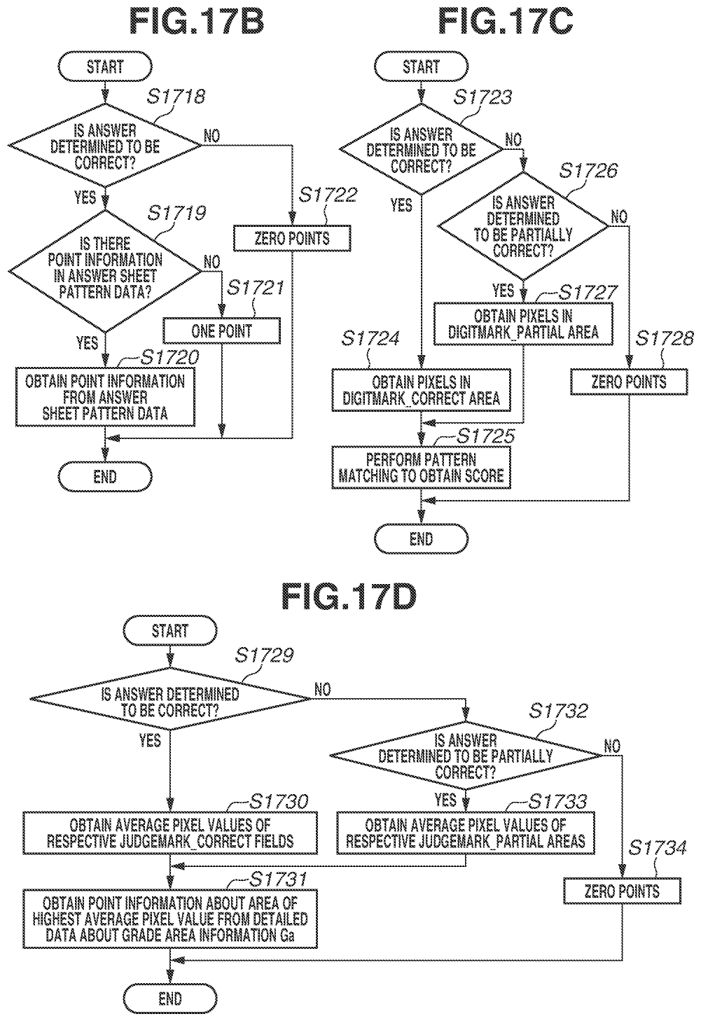

FIG. 17A is a flowchart of marking result obtaining processing on pixels in a data area according to the fifth exemplary embodiment. The processing of this flowchart is performed by the CPU 101 reading a program stored in a ROM 102 into a DRAM 103 and running the program. The marking result of each question can be obtained by the processing of this flowchart.

In step S1701, the CPU 101 checks whether the question format is a multiple-choice question. If the question format is a multiple-choice question (YES in step S1701), the processing proceeds to step S1702. If the question format is not a multiple-choice question (NO in step S1701), the processing proceeds to step S1707.

In step S1702, the CPU 101 calculates an average value Mean of the pixel values in the data area. The processing proceeds to step S1703. Here, the average value Mean is calculated by using a typical conventional means.

In step S1703, the CPU 101 checks whether the average value Mean of the pixel values calculated in step S1702 is greater than or equal to a predetermined threshold. If the average value Mean is greater than or equal to the threshold (YES in step S1703), the processing proceeds to step S1704. If the average value Mean is less than the threshold (NO in step S1703), the processing proceeds to step S1705.

In step S1704, the CPU 101 determines that the answer to the target question is incorrect. The processing proceeds to step S1706.

In step S1705, the CPU 101 determines that the answer to the target question is correct. The processing proceeds to step S1706.

In step S1706, the CPU 101 performs score obtaining processing. The processing of this flowchart ends. Details of the score obtaining processing will be described below with reference to another flowchart.

In step S1707, the CPU 101 obtains pixels in the grade area. The processing proceeds to step S1708.

In step S1708, the CPU 101 obtains the average pixel values of the respective marking types in the grade area. The processing proceeds to step S1709.

In step S1709, the CPU 101 checks whether the marking type of the area of the highest average pixel value is x. If the marking type is x (YES in step S1709), the processing proceeds to step S1710. If the marking type is not x (NO in step S1709), the processing proceeds to step S1711.

In step S1710, the CPU 101 determines that the answer to the target question is incorrect. The processing proceeds to step S1714.

In step S1711, the CPU 101 checks whether the marking type of the area of the highest average pixel value is ∘. If the marking type is ∘ (YES in step S1711), the processing proceeds to step S1712. If the marking type is not ∘ (NO in step S1711), the processing proceeds to step S1713.

In step S1712, the CPU 101 determines that the answer to the target question is correct. The processing proceeds to step S1714.

In step S1713, the CPU 101 determines that the answer to the target question is partially correct. The processing proceeds to step S1714.

In step S1714, the CPU 101 checks whether the grade type is JUDGE_WITH_DIGIT indicating the addition of a digit mark area. If the grade type is JUDGE_WITH_DIGIT indicating the addition of a digit mark area (YES in step S1714), the processing proceeds to step S1716. If the grade type is not JUDGE_WITH_DIGIT indicating the addition of a digit mark area (NO in step S1714), the processing proceeds to step S1715.

In step S1715, the CPU 101 checks whether the grade type is JUDGE_MULTIPLE indicating the addition of as many point mark fields as the number of points. If the grade type is JUDGE_MULTIPLE indicating the addition of as many point mark fields as the number of points (YES in step S1715), the processing proceeds to step S1717. If the grade type is not JUDGE_MULTIPLE indicating the addition of as many point mark fields as the number of points (NO in step S1715), the processing proceeds to step S1706.

In step S1716, the CPU 101 performs point mark digit field-specific score obtaining processing. The processing of this flowchart ends. Details of the point mark digit field-specific score obtaining processing will be described below with reference to another flowchart.

In step S1717, the CPU 101 performs as many point mark fields as number of points added-specific score obtaining processing. The processing of this flowchart ends. Details of the as many point mark fields as number of points added-specific score obtaining processing will be described below with reference to another flowchart.

FIG. 17B is a flowchart for obtaining the score on a question (score obtaining processing) according to the fifth exemplary embodiment. The processing of this flowchart is performed by the CPU 101 reading a program stored in the ROM 102 into the DRAM 103 and running the program. The score on a question is obtained by the processing of this flowchart.

In step S1718, the CPU 101 checks whether the answer to the question is determined to be correct. If the answer is determined to be correct (YES in step S1718), the processing proceeds to step S1719. If the answer is not determined to be correct (NO in step S1718), the processing proceeds to step S1722.

In step S1719, the CPU 101 checks whether there is point information in the answer sheet pattern data. If there is point information (YES in step S1719), the processing proceeds to step S1720. If there is no point information (NO in step S1719), the processing proceeds to step S1721.

In step S1720, the CPU 101 obtains the score from the point information about this question element in the answer sheet pattern data. The processing of this flowchart ends.

In step S1721, the CPU 101 determines that the score is one point. The processing of this flowchart ends.

In step S1722, the CPU 101 determines that the score is zero points. The processing of this flowchart ends.

FIG. 17C is a flowchart of the point mark digit field-specific score obtaining processing according to the fifth exemplary embodiment. The score on a question with a point mark digit field is obtained by the processing of this flowchart.

In step S1723, the CPU 101 checks whether the answer to the question is determined to be correct. If the answer is determined to be correct (YES in step S1723), the processing proceeds to step S1724. If the answer is not determined to be correct (NO in step S1723), the processing proceeds to step S1726.

In step S1724, the CPU 101 obtains pixels in the DIGITMARK_CORRECT area. The processing proceeds to step S1725.

In step S1725, the CPU 101 performs pattern matching on the obtained pixels to obtain the score. The processing of this flowchart ends. The pattern matching in this processing can be performed by typical conventional matching processing. Examples include using the sum of squares of differences in pixel value, and using the sum of absolute values of differences in pixel value.

In step S1726, the CPU 101 checks whether the answer to the question is determined to be partially correct. If the answer is determined to be partially correct (YES in step S1726), the processing proceeds to step S1727. If the answer is not determined to be partially correct (NO in step S1726), the processing proceeds to step S1728.

In step S1727, the CPU 101 obtains pixels in the DIGITMARK_PARTIAL area. The processing proceeds to step S1725.

In step S1728, the CPU 101 determines that the score is zero points. The processing of this flowchart ends.

FIG. 17D is a flowchart of the as many point mark fields as number of points added-specific score obtaining processing according to the fifth exemplary embodiment. The processing of this flowchart is performed by the CPU 101 reading a program stored in the ROM 102 into the DRAM 103 and running the program. The score on a question with as many point mark fields as the number of points is obtained by the processing of this flowchart.

In step S1729, the CPU 101 checks whether the answer to the question is determined to be correct. If the answer is determined to be correct (YES in step S1729), the processing proceeds to step S1730. If the answer is not determined to be correct (NO in step S1729), the processing proceeds to step S1732.

In step S1730, the CPU 101 obtains the average pixel values of the respective JUDGEMARK_CORRECT areas. The processing proceeds to step S1731. Here, the average pixel values are obtained by using a typical conventional technique, such as dividing an integrated pixel value by the area.

In step S1731, the CPU 101 obtains the point information about the area of the highest average pixel value of the obtained average pixel values of all the areas from the detailed data on the grade area information Ga. The processing of this flowchart ends.

In step S1732, the CPU 101 checks whether the answer to the question is determined to be partially correct. If the answer is determined to be partially correct (YES in step S1732), the processing proceeds to step S1733. If the answer is not determined to be partially correct (NO in step S1732), the processing proceeds to step S1734.

In step S1733, the CPU 101 obtains the average pixel values of the respective JUDGEMARK_PARTIAL areas. The processing proceeds to step S1731.

In step S1734, the CPU 101 determines that the score is zero points. The processing of this flowchart ends.

As described above, a system can be provided that generates and prints answer sheets that support partially correct answers Δ as well as correct answers ∘ and incorrect answers x, and performs marking and aggregation.

In the first to fifth exemplary embodiments, multiple-choice questions are first drawn and then free-form questions in drawing order. However, multiple-choice questions and free-form questions can be asked in mixed order. A sixth exemplary embodiment deals with a system capable of rearranging questions. Again, differences between the sixth exemplary embodiment and the foregoing exemplary embodiments will be described.

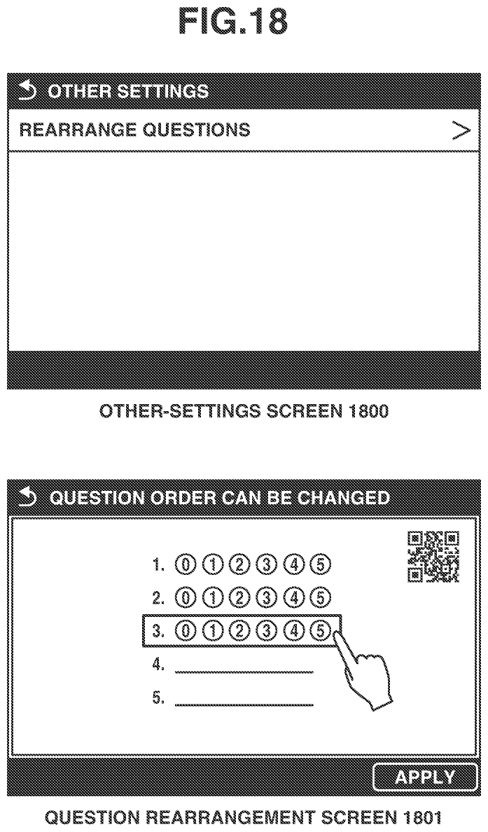

FIG. 18 illustrates an other-settings screen 1800 and a question rearrangement screen 1801 associated with an answer sheet generation and print screen.

The other-settings screen 1800 is a screen displayed by an other-settings button being pressed on the answer sheet generation and print screen. The screen can be made to transition to the question rearrangement screen 1801 by a rearrange questions button being pressed. Since the present exemplary embodiment deals mainly with the function of rearranging questions, the other-settings screen 1800 displays the one item alone.

The question rearrangement screen 1801 is a screen for rearranging questions. The displayed answer sheet data can be scrolled like the preview display illustrated in FIG. 1B, and questions can be rearranged by a finger selecting a question to be rearranged with a long tap on an operation unit 104 and being released after rearrangement. An apply button is then pressed to apply the change.

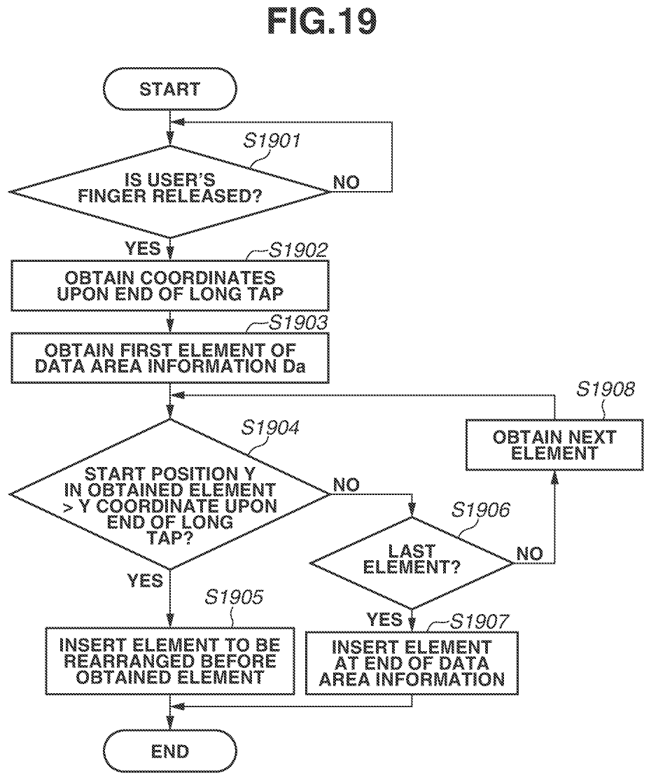

FIG. 19 is a flowchart to be performed after a question to be rearranged is selected with a long tap. The processing of this flowchart is performed by a CPU 101 reading a program stored in a ROM 102 into a DRAM 103 and running the program. Rearrangement processing is performed by the processing of this flowchart.

In step S1901, the CPU 101 checks whether the user's finger is released from the operation unit 104. If the finger is released (YES in step S1901), the processing proceeds to step S1902. If the finger is not released (NO in step S1901), the processing returns to step S1901 to wait until the user releases the finger, since the user is currently rearranging questions.

In step S1902, the CPU 101 obtains the coordinates upon the end of the long tap. The processing proceeds to step S1903.

In step S1903, the CPU 101 obtains the first element of the data area information Da. The processing proceeds to step S1904.

In step S1904, the CPU 101 checks whether the Y coordinate of the start position in the obtained element is greater than the Y coordinate upon the end of the long tap. If the Y coordinate of the start position in the obtained element is greater than the Y coordinate upon the end of the long tap (YES in step S1904), the processing proceeds to step S1905. If the Y coordinate of the start position in the obtained element is less than or equal to the Y coordinate upon the end of the long tap (NO in step S1904), the processing proceeds to step S1906.

In step S1905, the CPU 101 inserts the element to be rearranged before the obtained element. The processing of this flowchart ends.

In step S1906, the CPU 101 checks whether the obtained element is the last element of the data area information Da. If the obtained element is the last one (YES in step S1906), the processing proceeds to step S1907. If the obtained element is not the last one (NO in step S1906), the processing proceeds to step S1908.

In step S1907, the CPU 101 inserts the element to be rearranged at the end of the data area information Da. The processing of this flowchart ends.

In step S1908, the CPU 101 obtains the next element of the data area information Da. The processing proceeds to step S1904.

As described above, a system can be obtained that generates and prints answer sheets where questions can be rearranged, and performs marking and aggregation.

In the first to sixth exemplary embodiments, the answer fields for the free-form questions are fixed in size. However, it is sometimes desirable to increase or decrease, i.e., adjust the size of the answer fields depending the content of the free-form questions. A seventh exemplary embodiment deals with a system that supports adjustments in the size of the answer fields of the free-form questions. Again, differences between the seventh exemplary embodiment and the foregoing exemplary embodiments will be described.

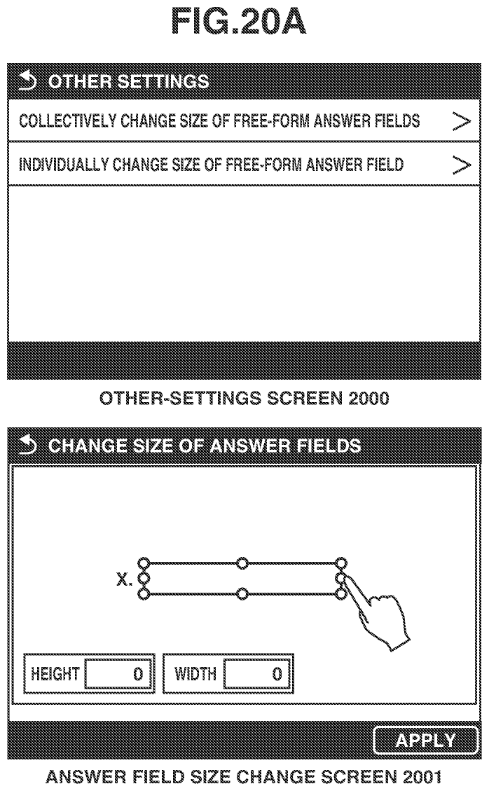

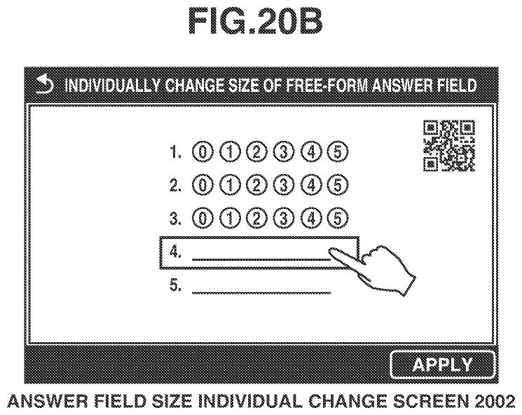

FIGS. 20A and 20B illustrate an other-settings screen 2000 to which an answer sheet generation and print screen can transition, and an answer field size change screen 2001 and an answer field size individual change screen 2002.

The other-settings screen 2000 is a screen displayed by the other-settings button being pressed on the answer sheet generation and print screen. If a collectively change size of free-form answer fields button is pressed, the other-settings screen 2000 transitions to the answer field size change screen 2001, where the size of the answer fields for all the free-form questions can be adjusted. If an individually change size of free-form answer field button is pressed, the other-settings screen 2000 transitions to the answer field size individual change screen 2002, where the question to change the size of an answer field for can be selected and the size can be changed. Since the present exemplary embodiment deals mainly with the function of changing the size of the answer field(s) of a question or questions, the other-settings screen 2000 displays the two items alone.

The answer field size change screen 2001 is capable of collectively changing the size of the answer fields for all the free-form questions. The size can be changed by a tap on an answer field with eight adjustment markers displayed on an operation unit 104 or by a tap on the height and width displayed to the bottom left and inputting adjustment values. To input the adjustment values, the same input screen as the point input screen 1004 illustrated in FIG. 10B is displayed. The apply button is then pressed to apply the change.

The answer field size individual change screen 2002 is a screen for selecting the question to change the size of an answer field for and individually changing the size. The displayed answer sheet data can be scrolled like the preview screen illustrated in FIG. 1B, and the question to change the size of an answer field for can be selected by a tap on the operation unit 104. If a question is tapped, the answer field size change screen 2001 is displayed and the size can be changed. The apply button is then pressed to apply the change.

As described above, a system can be provided that generates and prints answer sheets where the size of the answer fields for free-form questions can be changed, and performs marking and aggregation.

In the first to seventh exemplary embodiments, the information on each question is obtained and marking and aggregation are performed by using the answer sheet pattern DB illustrated in FIG. 3A. However, a multifunction peripheral 100 that generates and prints answer sheets may be different from one that performs marking and aggregation. In such a case, the marking and aggregation are unable to be performed due to the absence of the answer sheet pattern DB. An eighth exemplary embodiment deals with a system where, if there is no answer sheet pattern DB, answer sheet pattern data can be generated to enable marking and aggregation through image analysis on image data on correct-answer and answer sheets. Again, differences between the eighth exemplary embodiment and the foregoing exemplary embodiments will be described.

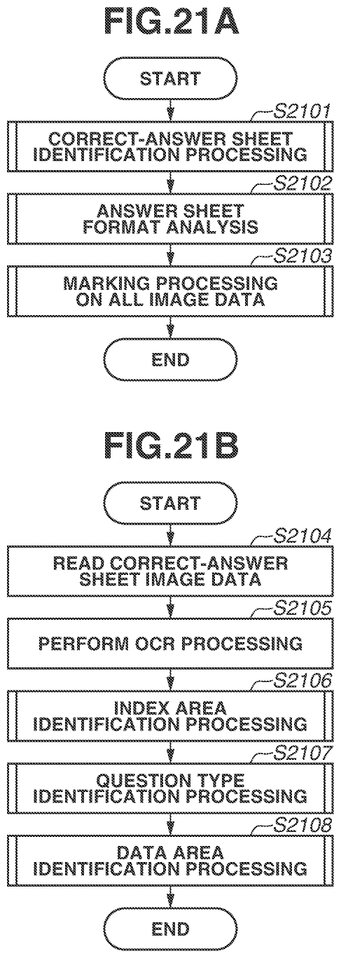

FIG. 21A is a flowchart of marking processing performed in the eighth exemplary embodiment. The processing of this flowchart is performed a CPU 101 reading a program stored in a ROM 102 into a DRAM 103 and running the program. By the processing of this flowchart, marking can be performed even if there is no answer sheet pattern DB.

In step S2101, the CPU 101 performs correct-answer sheet identification processing. The processing proceeds to step S2102. The correct-answer sheet identification processing is similar to that illustrated in FIG. 7C, and a description thereof will thus be omitted.

In step S2102, the CPU 101 performs an answer sheet format analysis. The processing proceeds to step S2103.

In step S2103, the CPU 101 performs marking processing on all pages (image data) scanned. The processing of this flowchart ends. The marking processing is similar to that illustrated in FIG. 7D, and a description thereof will thus be omitted.

FIG. 21B is a flowchart of the answer sheet format analysis performed in the eighth exemplary embodiment. The format of an answer sheet is analyzed and answer sheet pattern data is generated by the processing of this flowchart.

In step S2104, the CPU 101 reads correct-answer sheet image data from the ROM 102 or the DRAM 103. The processing proceeds to step S2105.

In step S2105, the CPU 101 performs optical character recognition (OCR) processing on the read correct-answer sheet image data. The processing proceeds to step S2106. The OCR processing is performed by using typical conventional processing.

In step S2106, the CPU 101 performs processing for identifying index areas (index area identification processing). The processing proceeds to step S2107.

In step S2107, the CPU 101 performs question type identification processing. The processing proceeds to step S2108.

In step S2108, the CPU 101 performs data area identification processing. The processing of this flowchart ends.

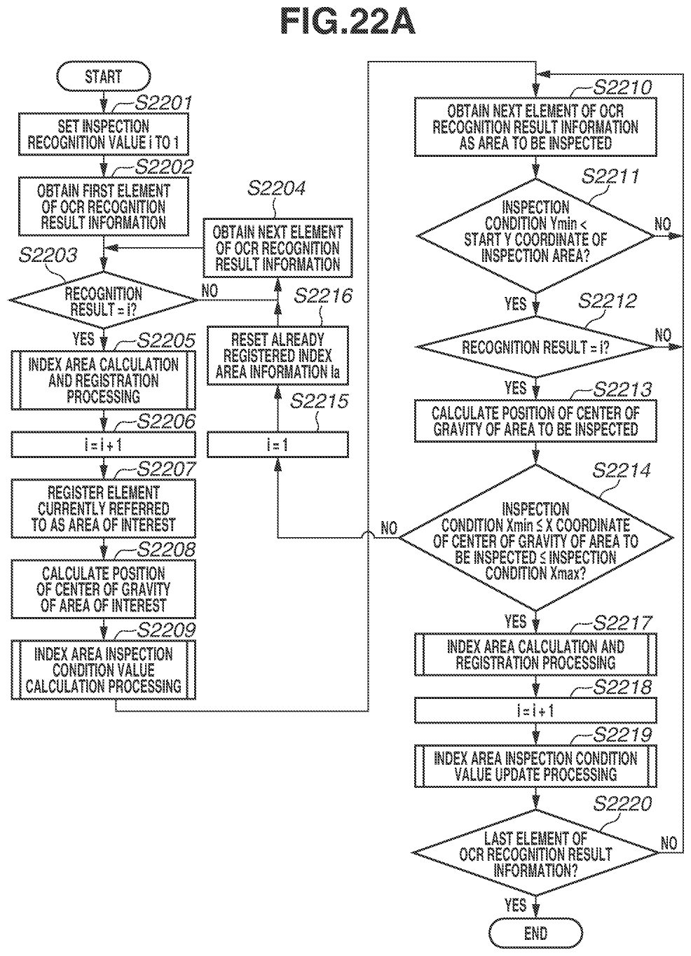

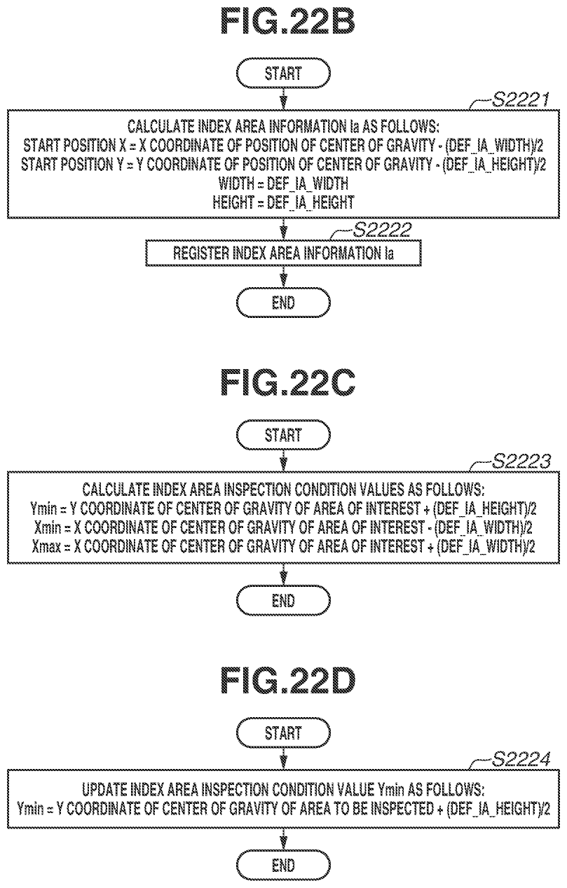

FIG. 22A is a flowchart of the index area identification processing performed in the eighth exemplary embodiment. The processing of this flowchart is performed by the CPU 101 reading a program stored in the ROM 102 into the DRAM 103 and running the program. The index areas of the respective questions in the image data are identified and index area information Ia is generated and registered by the processing of this flowchart.

In step S2201, the CPU 101 sets an inspection recognition value i to 1. The processing proceeds to step S2202.

In step S2202, the CPU 101 obtains the first element of OCR recognition result information (information resulting from the foregoing OCR processing). The processing proceeds to step S2203.

In step S2203, the CPU 101 checks whether the recognition result of the obtained element agrees with the inspection recognition value i. If the recognition result agrees with the inspection recognition value i (YES in step S2203), the processing proceeds to step S2205. If the recognition result does not agree with the inspection recognition value i (NO in step S2203), the processing proceeds to step S2204. Since the numbers of the index areas are consecutive numbers starting at 1, a candidate for the first index area can be obtained by this processing.

In step S2204, the CPU 101 obtains the next element of the OCR recognition result information. The processing proceeds to step S2203.

In step S2205, the CPU 101 performs index area calculation and registration processing on the obtained element. The processing proceeds to step S2206. Details of the index area calculation and registration processing will be described below with reference to another flowchart.

In step S2206, the CPU 101 adds 1 to the inspection recognition value i. The processing proceeds to step S2207. This enables appropriate recognition of the consecutive numbers of the index areas.

In step S2207, the CPU 101 registers the element of the OCR recognition result information currently referred to as an area of interest. The processing proceeds to step S2208.

In step S2208, the CPU 101 calculates the position of the center of gravity of the area of the interest. The processing proceeds to step S2209.

In step S2209, the CPU 101 calculates index area inspection condition values (index area inspection condition value calculation processing). The processing proceeds to step S2210. Subsequent index areas are identified using the index area inspection condition values calculated in this step.

In step S2210, the CPU 101 obtains the next element of the OCR recognition result information as an area to be inspected. The processing proceeds to step S2211. From this step on, index areas subsequent to the initial index area registered as an area of interest in step S2207 are identified.

In step S2211, the CPU 101 checks whether an inspection condition Ymin is less than the start Y coordinate of the area to be inspected. If the inspection condition (hereinafter, may be referred to as index area inspection condition value) Ymin is less than the start Y coordinate of the area to be inspected (YES in step S2211), the processing proceeds to step S2212. If the inspection condition Ymin is greater than or equal to the start Y coordinate of the area to be inspected (NO in step S2211), the processing proceeds to step S2210.

In step S2212, the CPU 101 checks whether the recognition result of the element of the OCR recognition result information obtained as the area to be inspected agrees with the inspection recognition value i. If the recognition result agrees with the inspection recognition value i (YES in step S2212), the processing proceeds to step S2213. If the recognition result does not agree with the inspection recognition value i (NO in step S2212), the processing proceeds to step S2210.

In step S2213, the CPU 101 calculates the position of the center of gravity of the area to be inspected. The processing proceeds to step S2214.

In step S2214, the CPU 101 checks whether an inspection condition (index area inspection condition value) Xmin is less than or equal to the X coordinate of the center of gravity of the area to be inspected and the X coordinate of the center of gravity of the area to be inspected is less than or equal to an inspection condition (index area inspection condition value) Xmax. If such a condition is satisfied (YES in step S2214), the processing proceeds to step S2217. If not (NO in step S2214), the processing proceeds to step S2215. Since index areas are drawn at the same distances from the left end of the image data, an index area can be identified based on whether the X coordinate satisfies the condition in this step.

In step S2215, the CPU 101 sets the inspection recognition value i to 1. The processing proceeds to step S2216. This step S2215 causes the CPU 101 to perform processing for searching for the first index area again.

In step S2216, the CPU 101 resets already registered index area information Ia. The processing proceeds to step S2204.

In step S2217, the CPU 101 performs index area calculation and registration processing on the area to be inspected. The processing proceeds to step S2218. The index area calculation and registration processing performed here is similar to that in step S2205.

In step S2218, the CPU 101 adds 1 to the inspection recognition value i. The processing proceeds to step S2219. This enables appropriate recognition of the consecutive numbers of the index areas.

In step S2219, the CPU 101 updates the index area inspection condition values (index area inspection condition value update processing). The processing proceeds to step S2220.

In step S2220, the CPU 101 checks whether the element of the OCR recognition result information obtained as the area to be inspected is the last element. If the obtained element is the last one (YES in step S2220), the processing of this flowchart ends. If the obtained element is not the last one (NO in step S2220), the processing proceeds to step S2210.

FIG. 22B is a flowchart of the index area identification processing performed in the eighth exemplary embodiment. The processing of this flowchart is performed by the CPU 101 reading a program stored in the ROM 102 into the DRAM 103 and running the program. The index area of each question in the image data is identified and index area information Ia is generated and registered by the processing of this flowchart.

In step S2221, the CPU 101 calculates the index area information Ia. The processing proceeds to step S2222. Here, the width and the height of the index area are set to default values DEF_IA_WIDTH and DEF_IA_HEIGHT, respectively. The X and Y coordinates of the start position (may be referred to as a start position X and a start position Y, respectively) are calculated by subtracting one-halves of the width and height from the X and Y coordinates of the position of the center of gravity, respectively.

In step S2222, the CPU 101 registers the index area information Ia calculated in step S2221 in the answer sheet pattern data on the DRAM 103. The processing of this flowchart ends.

FIG. 22C is a flowchart of the index area inspection condition value calculation processing performed in the eighth exemplary embodiment. The condition values for inspecting whether an area to be inspected is an index area are calculated by the processing of this flowchart.

In step S2223, the CPU 101 calculates the index area inspection condition values Ymin, Xmin, and Xmax. The processing of this flowchart ends. To exclude elements located at the same Y coordinate as that of the area of interest from inspection, Ymin is calculated by adding DEF_IA_HEIGHT/2 to the Y coordinate of the center of gravity of the area of interest. Xmin is calculated by subtracting DEF_IA_WIDTH/2 from the X coordinate of the center of gravity of the area of interest, and Xmax by adding DEF_IA_WIDTH/2 to the X coordinate, since index areas are drawn at the same distances from the left end of the image.

FIG. 22D is a flowchart of the index area inspection condition value update processing performed in the eighth exemplary embodiment. The processing of this flowchart is performed by the CPU 101 reading a program stored in the ROM 102 into the DRAM 103 and running the program. By the processing of this flowchart, the index area inspection condition value Ymin is updated based on the inspection recognition value i of the area to be inspected.

In step S2224, the CPU 101 updates the index area inspection condition value Ymin. The processing of this flowchart ends. To exclude elements located at the same Y coordinate as that of the area to be inspected from inspection, Ymin is updated to a coordinate obtained by adding DEF_IA_HEIGHT/2 to the Y coordinate of the center of gravity of the area to be inspected.

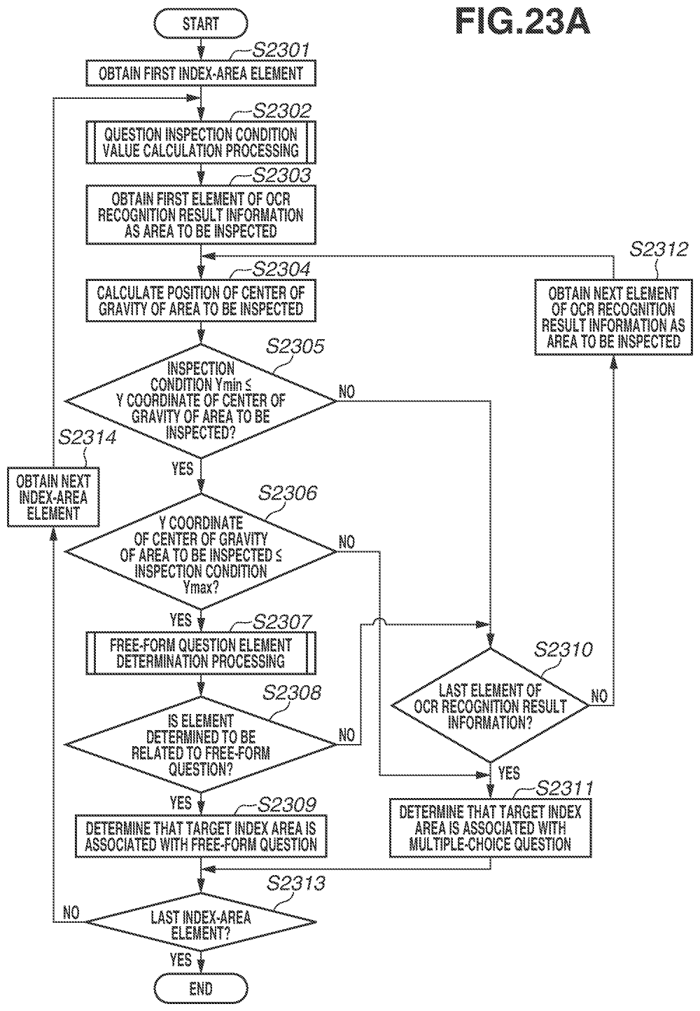

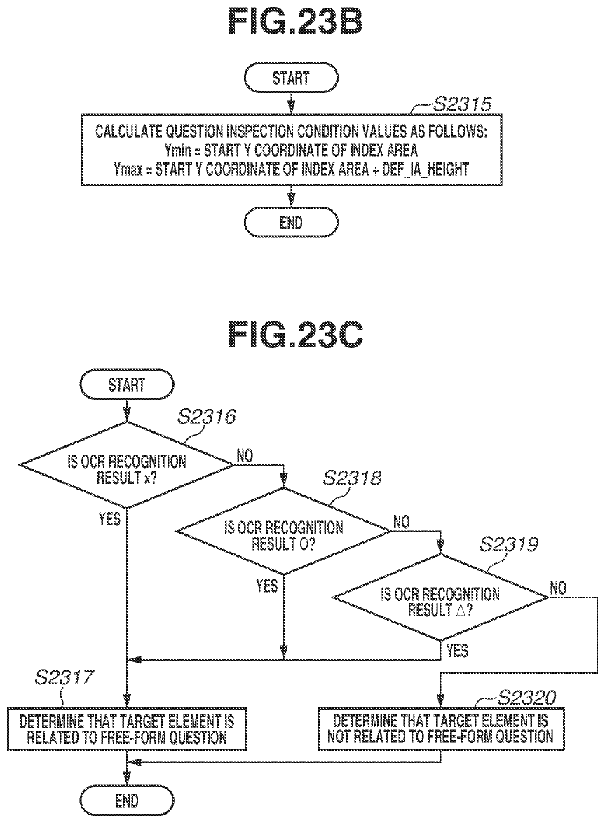

FIG. 23A is a flowchart of the question type identification processing performed in the eighth exemplary embodiment. The processing of this flowchart is performed by the CPU 101 reading a program stored the ROM 102 into the DRAM 103 and running the program. Whether a question associated with each index area is a free-form question or a multiple-choice question is determined by the processing of this flowchart.

In step S2301, the CPU 101 obtains the first index-area element. The processing proceeds to step S2302.

In step S2302, the CPU 101 calculates a question inspection condition value (question inspection condition value calculation processing). The processing proceeds to step S2303. Details of the question inspection condition value calculation processing will be described below with reference to another flowchart.

In step S2303, the CPU 101 obtains the first element of the OCR recognition result information as an area to be inspected. The processing proceeds to step S2304.

In step S2304, the CPU 101 calculates the position of the center of gravity of the area to be inspected. The processing proceeds to step S2305.

In step S2305, the CPU 101 checks whether the Y coordinate of the center of gravity of the area to be inspected is greater than or equal to the inspection condition Ymin. If the Y coordinate is greater than or equal to Ymin (YES in step S2305), the processing proceeds to step S2306. If the Y coordinate is less than Ymin (NO in step S2305), the processing proceeds to step S2310. By this determination processing, the elements of the OCR recognition result information associated with index areas other than the target index area can be excluded.

In step S2306, the CPU 101 checks whether the Y coordinate of the center of gravity of the area to be inspected is less than or equal to an inspection condition Ymax to be described below. If the Y coordinate is less than or equal to Ymax (YES in step S2306), the processing proceeds to step S2307. If the Y coordinate is greater than Ymax (NO in step S2306), the processing proceeds to step S2311. By this determination processing, the elements of the OCR recognition result information associated with index areas other than the target index area can be excluded in determining the type of question.

In step S2307, the CPU 101 determines whether the element to be inspected is one including information about a free-form question (free-form question element determination processing). The processing proceeds to step S2308.

In step S2308, the CPU 101 checks whether the element to be inspected is determined to be related to a free-form question in step S2307. If the element is determined to be related to a free-form question (YES in step S2308), the processing proceeds to step S2309. If the element is not determined to be related to a free-form question (NO in step S2308), the processing proceeds to step S2310.

In step S2309, the CPU 101 determines that the target index area is associated with a free-form question. The processing proceeds to step S2313.

In step S2310, the CPU 101 checks whether the element of the OCR recognition result information currently handled as the area to be inspected is the last element. If the element is the last one (YES in step S2310), the processing proceeds to step S2311.

If the element is not the last one (NO in step S2310), the processing proceeds to step S2312.

In step S2311, the CPU 101 determines that the target index area is associated with a multiple-choice question. The processing proceeds to step S2313.

In step S2312, the CPU 101 obtains the next element of the OCR recognition result information as an area to be inspected. The processing proceeds to step S2304.

In step S2313, the CPU 101 checks whether the index-area element currently referred to is the last one. If the index-area element is the last one (YES in step S2313), the processing of this flowchart ends. If the index-area element is not the last one (NO in step S2313), the processing proceeds to step S2314.

In step S2314, the CPU 101 obtains the next index-area element. The processing proceeds to step S2302.

FIG. 23B illustrates a flowchart of the question inspection condition value calculation processing performed in the eighth exemplary embodiment. The processing of this flowchart is performed by the CPU 101 reading a program stored in the ROM 102 into the DRAM 103 and running the program. The question inspection condition values Ymin and Ymax for determining whether an element is a question element associated with the target index area are calculated by the processing of this flowchart.

In step S2315, the CPU 101 calculates the question inspection condition values Ymin and Ymax. The processing of this flowchart ends.

The inspection condition Ymin that is the lower limit of the Y coordinate of the target element is set to the start Y coordinate of the index area. The inspection condition Ymax that is the upper limit of the Y coordinate is calculated by adding DEF_IA_HEIGHT to the start Y coordinate of the index area.

FIG. 23C illustrates a flowchart of the free-form question element determination processing performed in the eighth exemplary embodiment. Whether the element to be inspected is related to a free-form question is determined by the processing of this flowchart.

In step S2316, the CPU 101 checks whether the recognition result of the target element is x. If the recognition result is x (YES in step S2316), the processing proceeds to step S2317. If the recognition result is not x (NO in step S2316), the processing proceeds to step S2318.

In step S2317, the CPU 101 determines that the target element is related to a free-form question. The processing of this flowchart ends.

In step S2318, the CPU 101 checks whether the recognition result of the target element is ∘. If the recognition result is ∘ (YES in step S2318), the processing proceeds to step S2317. If the recognition result is not ∘ (NO in step S2318), the processing proceeds to step S2319.

In step S2319, the CPU 101 checks whether the recognition result of the target element is Δ. If the recognition result is Δ (YES in step S2318), the processing proceeds to step S2317. If the recognition result is not Δ (NO in step S2319), the processing proceeds to step S2320.

In step S2320, the CPU 101 determines that the target element is not related to a free-form question. The processing of this flowchart ends.

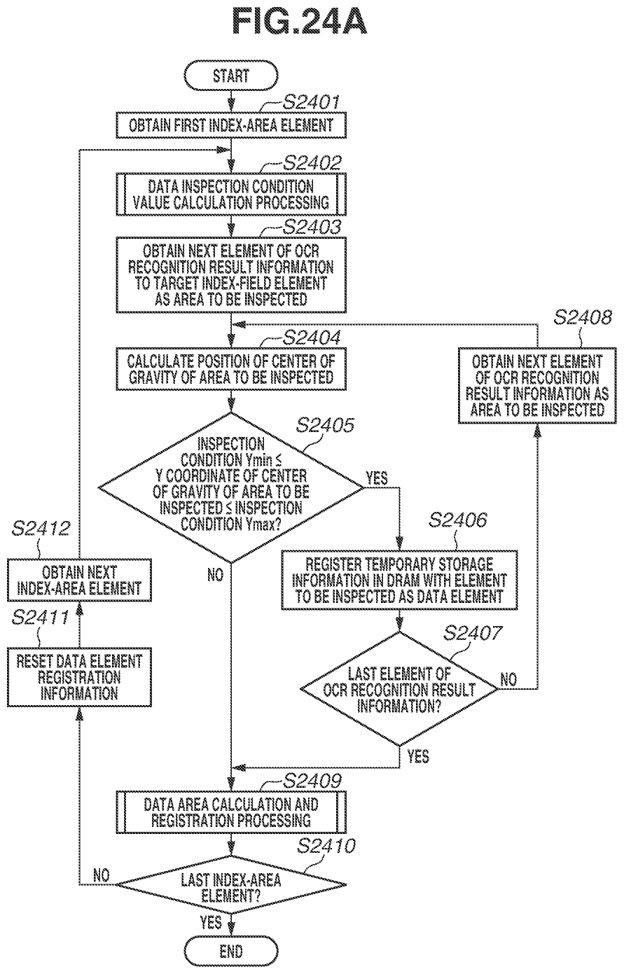

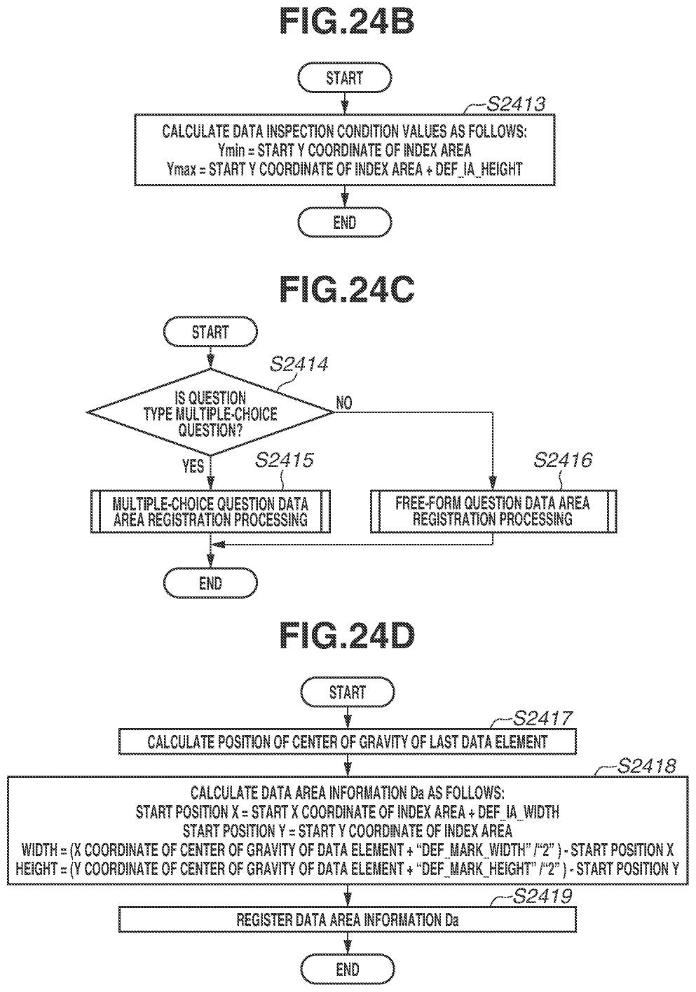

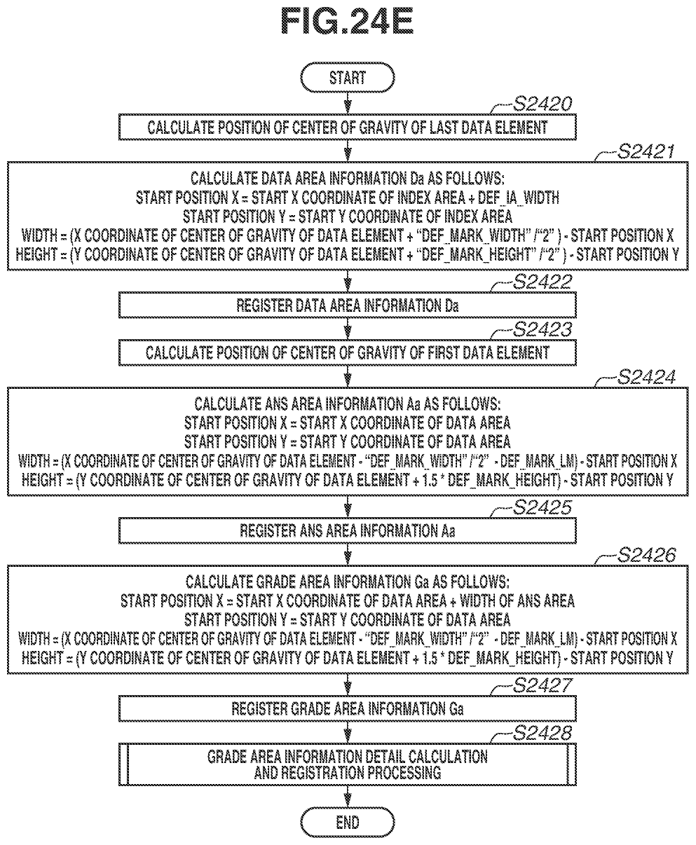

FIG. 24A illustrates a flowchart of the data area identification processing performed in the eighth exemplary embodiment. The processing of this flowchart is performed by the CPU 101 reading a program stored in the ROM 102 into the DRAM 103 and running the program. A data area associated with each index area is identified and registered in answer sheet pattern data by the processing of this flowchart.

In step S2401, the CPU 101 obtains the first index-area element. The processing proceeds to step S2402.

In step S2402, the CPU 101 calculates data inspection condition values (data inspection condition value calculation processing). The processing proceeds to step S2403. Details of the data inspection condition value calculation processing will be described below with reference to another flowchart.

In step S2403, the CPU 101 obtains the element of the OCR recognition result information subsequent to the target index-area element as an area to be inspected. The processing proceeds to step S2404.

In step S2404, the CPU 101 calculates the position of the center of gravity of the area to be inspected. The processing proceeds to step S2405.

In step S2405, the CPU 101 checks whether the Y coordinate of the center of gravity of the area to be inspected is greater than or equal to an inspection condition Ymin and less than or equal to an inspection condition Ymax. If the condition is satisfied (YES in step S2405), the processing proceeds to step S2406. If the condition is not satisfied (NO in step S2405), the processing proceeds to step S2409.

In step S2406, the CPU 101 registers temporary storage information (hereinafter, referred to as data element registration information) in the DRAM 103 with the element to be inspected as a data element. The processing proceeds to step S2407.

In step S2407, the CPU 101 checks whether the element to be inspected is the last element of the OCR recognition result information. If the element is the last one (YES in step S2407), the processing proceeds to step S2409. If the element is not the last one (NO in step S2407), the processing proceeds to step S2408.

In step S2408, the CPU 101 obtains the next element of the OCR recognition result information as an area to be inspected. The processing proceeds to step S2404.

In step S2409, the CPU 101 performs data area calculation and registration processing. The processing proceeds to step S2410.

In step S2410, the CPU 101 checks whether the index-area element currently referred to is the last one. If the index-area element is the last one (YES in step S2410), the processing of this flowchart ends. If the index-area element is not the last one (NO in step S2410), the processing proceeds to step S2411.

In step S2411, the CPU 101 resets the data element registration information, i.e., the temporary storage information on the DRAM 103 for initialization. The processing proceeds to step S2412.

In step S2412, the CPU 101 obtains the next index-area element. The processing proceeds to step S2402.

FIG. 24B illustrates a flowchart of the data inspection condition value calculation processing performed in the eighth exemplary embodiment. The processing of this flowchart is performed by the CPU 101 reading a program stored in the ROM 102 into the DRAM 103 and running the program. Inspection conditions (data inspection condition values) for identifying a data-area element associated with an index area are calculated by the processing of this flowchart.

In step S2413, the CPU 101 calculates data inspection condition values Ymin and Ymax. The processing of this flowchart ends. To obtain an element located at the same Y coordinate as that of the index area, the data inspection condition value Ymin that is the lower limit value of the Y coordinate is set to the start Y coordinate of the index area. The data inspection condition value Ymax that is the upper limit value of the Y coordinate is calculated by adding DEF_IA_HEIGHT to the start Y coordinate of the index area.

FIG. 24C illustrates a flowchart of the data area calculation and registration processing performed in the eighth exemplary embodiment. The processing of this flowchart is performed by the CPU 101 reading a program stored in the ROM 102 into the DRAM 103 and running the program. Data area information Da is calculated and registered question by question by the processing of this flowchart.

In step S2414, the CPU 101 checks whether the question type of the target index field is a multiple-choice question. If the question type is a multiple-choice question (YES in step S2414), the processing proceeds to step S2415. If the question type is not a multiple-choice question (NO in step S2414), the processing proceeds to step S2416.

In step S2415, the CPU 101 performs multiple-choice question data area registration processing. The processing of this flowchart ends. Details of the multiple-choice question data area registration processing will be described below with reference to another flowchart.

In step S2416, the CPU 101 performs free-form question data area registration processing. The processing of this flowchart ends. Details of the free-form question data area registration processing will be described below with reference to another flowchart.

FIG. 24D illustrates a flowchart of the multiple-choice question data area registration processing performed in the eighth exemplary embodiment. The processing of this flowchart is performed by the CPU 101 reading a program stored in the ROM 102 into the DRAM 103 and running the program. Information about a multiple-choice question data area, such as a start position, width, and height, is calculated and registered in the answer sheet pattern data by the processing of this flowchart.

In step S2417, the CPU 101 obtains the last element of the data element registration information, and calculates the position of the center of gravity of the element. The processing proceeds to step S2418.

In step S2418, the CPU 101 calculates data area information Da. The processing proceeds to step S2419. As the data area information Da, the X coordinate of the start position is calculated by adding DEF_IA_WIDTH to the start X coordinate of the index area. The Y coordinate of the start position is set to the start Y coordinate of the index area. The width is calculated by adding DEF_MARK_WIDTH/2 to the X coordinate of the center of gravity of the data element and subtracting the start position X. The height is calculated by adding DEF_MARK_HEIGHT/2 to the Y coordinate of the center of gravity of the data element and subtracting the start position Y.

In step S2419, the CPU 101 registers the data area information Da calculated in step S2418 into the answer sheet pattern data. The processing of this flowchart ends.

FIG. 24E illustrates a flowchart of the free-form question data area registration processing performed in the eighth exemplary embodiment. The processing of this flowchart is performed by the CPU 101 reading a program stored in the ROM 102 into the DRAM 103 and running the program. Information about a free-form question data area, such as a start position, width, and height, is calculated and registered in the answer sheet pattern data by the processing of this flowchart.

In step S2420, the CPU 101 obtains the last element of the data element registration information, and calculates the position of the center of gravity of the element. The processing proceeds to step S2421.

In step S2421, the CPU 101 calculates data area information Da. The processing proceeds to step S2422. As the data area information Da, the X coordinate of the start position is calculated by adding DEF_IA_WIDTH to the start X coordinate of the index area. The Y coordinate of the start position is set to the start Y coordinate of the index area. The width is calculated by adding DEF_MARK_WIDTH/2 to the X coordinate of the center of gravity of the data element and subtracting the start position X. The height is calculated by adding DEF_MARK_HEIGHT/2 to the Y coordinate of the center of gravity of the data element and subtracting the start position Y.

In step S2422, the CPU 101 registers the data area information Da calculated in step S2421 into the answer sheet pattern data. The processing proceeds to step S2423.

In step S2423, the CPU 101 obtains the first element of the data element registration information, and calculates the position of the center of gravity of the element. The processing proceeds to step S2424.

In step S2424, the CPU 101 calculates ans area information Aa. The processing proceeds to step S2425. As the ans area information Aa, the X coordinate of the start position is set to the start X coordinate of the data area. The Y coordinate of the start position is set to the start Y coordinate of the data area. The width is calculated by subtracting DEF_MARK_WIDTH/2 and DEF_MARK_LM from the X coordinate of the center of gravity of the data element and further subtracting the start position X. The height is calculated by adding DEF_MARK_HEIGHT*1.5 to the Y coordinate of the center of gravity of the data element and subtracting the start position Y.

In step S2425, the CPU 101 registers the ans area information Aa calculated in step S2424 into the answer sheet pattern data. The processing proceeds to step S2426.

In step S2426, the CPU 101 calculates grade area information Ga. The processing proceeds to step S2427. As the grade area information Ga, the X coordinate of the start position is calculated by adding the width of the ans area to the start X coordinate of the data area. The Y coordinate of the start position is set to the start Y coordinate of the data area. The width is calculated by subtracting DEF_MARK_WIDTH/2 and DEF_MARK_LM from the X coordinate of the center of gravity of the data element and further subtracting the start position X. The height is calculated by adding DEF_MARK_HEIGHT*1.5 to the Y coordinate of the center of gravity of the data element and subtracting the start position Y.

In step S2427, the CPU 101 registers the grade area information Ga calculated in step S2426 into the answer sheet pattern data. The processing proceeds to step S2428.

In step S2428, the CPU 101 performs grade area information detail calculation and registration processing. The processing of this flowchart ends.

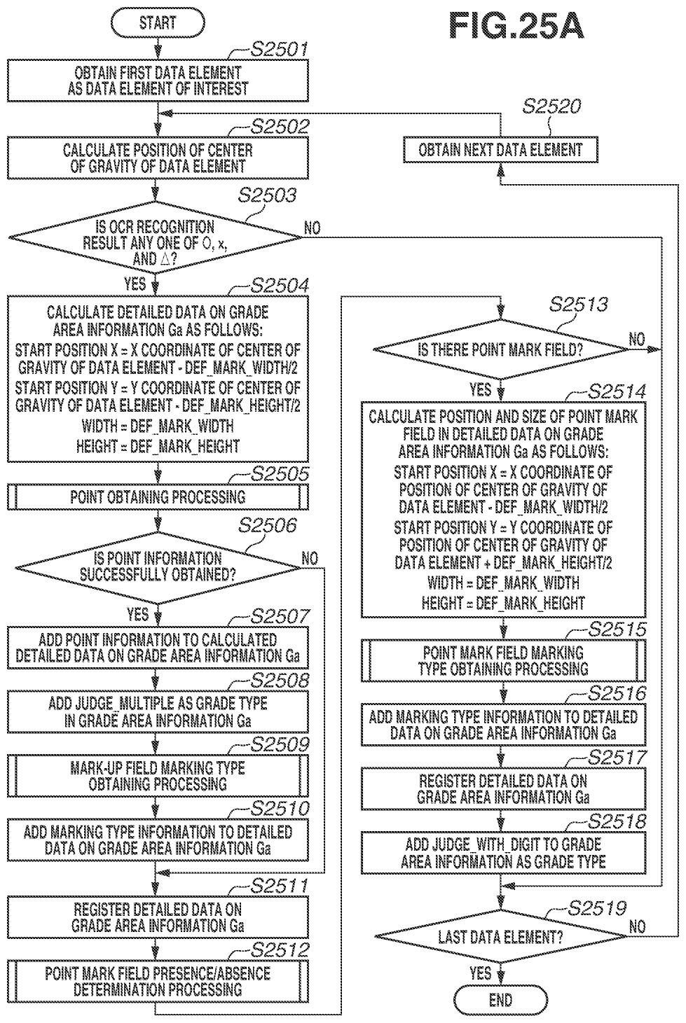

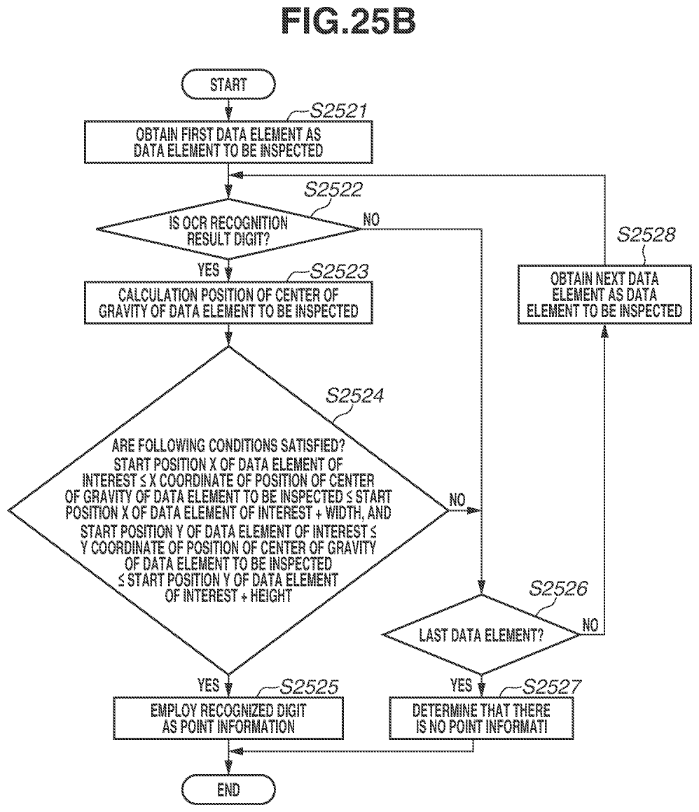

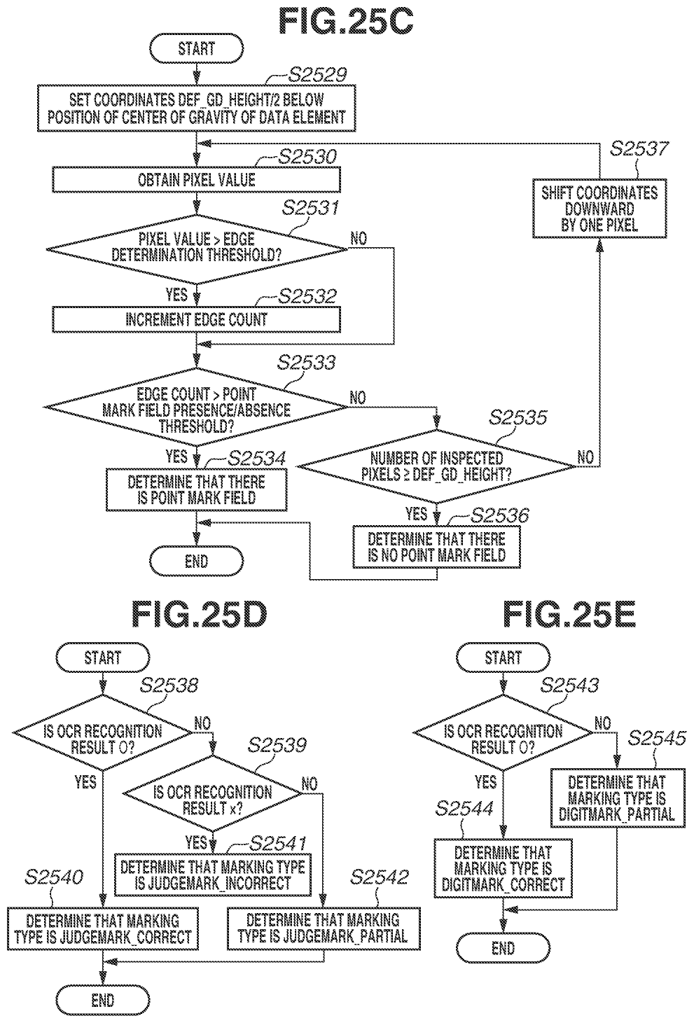

FIG. 25A illustrates a flowchart of the grade area information detail calculation and registration processing performed in the eighth exemplary embodiment. The processing of this flowchart is performed by the CPU 101 reading a program stored in the ROM 102 into the DRAM 103 and running the program. Detailed data on the grade area information Ga belonging to a free-form question grade area is calculated and registered by the processing of this flowchart.

In step S2501, the CPU 101 obtains the first data element as a data element of interest. The processing proceeds to step S2502.

In step S2502, the CPU 101 calculates the position of the center of gravity of the data element. The processing proceeds to step S2503.

In step S2503, the CPU 101 checks whether the recognition result of the data element of interest is ∘, x, or Δ. If the condition is satisfied (YES in step S2503), the processing proceeds to step S2504. If the condition is not satisfied (NO in step S2503), the processing proceeds to step S2519.

In step S2504, the CPU 101 calculates detailed data on the grade area information Ga. The processing proceeds to step S2505. The X coordinate of the start position is calculated by subtracting DEF_MARK_WIDTH/2 from the X coordinate of the position of the center of gravity of the data element. The Y coordinate is calculated by subtracting DEF_MARK_HEIGHT/2 from the Y coordinate of the position of the center of gravity of the data element. The width is set to DEF_MARK_WIDTH. The height is set to DEF_MARK_HEIGHT.

In step S2505, the CPU 101 performs point obtaining processing. The processing proceeds to step S2506. Details of the point obtaining processing will be described below with reference to another flowchart.

In step S2506, the CPU 101 checks whether point information is successfully obtained. If point information is successfully obtained (YES in step S2506), the processing proceeds to step S2507. If point information is not successfully obtained (NO in step S2506), the processing proceeds to step S2511.

In step S2507, the CPU 101 adds the point information to the calculated detailed data on the grade area information Ga. The processing proceeds to step S2508.

In step S2508, the CPU 101 adds JUDGE_MULTIPLE as the grade type in the grade area information Ga. The processing proceeds to step S2509.

In step S2509, the CPU 101 performs mark-up field marking type obtaining processing. The processing proceeds to step S2510. Details of the mark-up field marking type obtaining processing will be described below with reference to another flowchart.

In step S2510, the CPU 101 adds marking type information obtained in step S2509 to the detailed data on the grade area information Ga. The processing proceeds to step S2511.

In step S2511, the CPU 101 registers the generated detailed data on the grade area information Ga in the answer sheet pattern data. The processing proceeds to step S2512.

In step S2512, the CPU 101 performs point mark field presence/absence determination processing. The processing proceeds to step S2513. Details of the point mark field presence/absence determination processing will be described below with reference to another flowchart.

In step S2513, the CPU 101 checks whether there is a point mark field. If there is a point mark field (YES in step S2513), the processing proceeds to step S2514. If there is no point mark field (NO in step S2513), the processing proceeds to step S2519.

In step S2514, the CPU 101 calculates the position and size of the point mark field in the detailed data on the grade area information Ga. The processing proceeds to step S2515. The X coordinate of the start position is calculated by subtracting DEF_MARK_WIDTH/2 from the X coordinate of the position of the center of gravity of the data element. The Y coordinate is calculated by adding DEF_MARK_HEIGHT/2 to the Y coordinate of the position of the center of gravity of the data element. The width is set to DEF_MARK_WIDTH. The height is set to DEF_MARK_HEIGHT.

In step S2515, the CPU 101 performs point mark field marking type obtaining processing. The processing proceeds to step S2516. Details of the point mark field marking type obtaining processing will be described below with reference to another flowchart.

In step S2516, the CPU 101 adds marking type information about the point mark field obtained in step S2515 to the detailed data on the grade area information Ga. The processing proceeds to step S2517.

In step S2517, the CPU 101 registers the generated detailed data on the grade area information Ga in the answer sheet pattern data. The processing proceeds to step S2518.

In step S2518, the CPU 101 adds JUDGE_WITH_DIGIT as the grade type in the grade area information Ga. The processing proceeds to step S2519.

In step S2519, the CPU 101 checks whether the data element currently referred to is the last one. If the data element is the last one (YES in step S2519), the processing of this flowchart ends. If the data element is not the last one (NO in step S2519), the processing proceeds to step S2520.

In step S2520, the CPU 101 obtains the next data element. The processing proceeds to step S2502.

FIG. 25B illustrates a flowchart related to the grade-area point obtaining processing performed in the eighth exemplary embodiment. The processing of this flowchart is performed by the CPU 101 reading a program stored in the ROM 102 into the DRAM 103 and running the program. Point information in the grade area is obtained by the processing of this flowchart.

In step S2521, the CPU 101 obtains the first data element as a data element to be inspected. The processing proceeds to step S2522.

In step S2522, the CPU 101 checks whether the recognition result is a digit. If the recognition result is a digit (YES in step S2522), the processing proceeds to step S2523. If the recognition result is not a digit (NO in step S2522), the processing proceeds to step S2526. Whether the recognized character string is a digit can be determined by using a typical conventional means, such as an ordinary standard function.

In step S2523, the CPU 101 calculates the position of the center of gravity of the data element to be inspected. The processing proceeds to step S2524.

In step S2524, the CPU 101 checks whether the data element to be inspected satisfies conditions for the data element to be inspected to be employed as point information. If the conditions are satisfied (YES in step S2524), the processing proceeds to step S2525. If the conditions are not satisfied (NO in step S2524), the processing proceeds to step S2526. Here, the CPU 101 checks whether the recognized digit in the data area obtained to be inspected belongs to inside the area of interest. For that purpose, the CPU 101 checks whether the X coordinate of the center of gravity of the data element to be inspected is greater than or equal to the start position X of the data element of interest and less than or equal to the start position X+the width, and whether the Y coordinate of the position of the center of gravity of the data element to be inspected is greater than or equal to the start position Y of the data element of interest and less than or equal to the start position Y+the height.

In step S2525, the CPU 101 employs the recognized digit as point information. The processing of this flowchart ends.

In step S2526, the CPU 101 checks whether the data element currently referred to is the last one. If the data element is the last one (YES in step S2526), the processing proceeds to step S2527. If the data element is not the last one (NO in step S2526), the processing proceeds to step S2528.

In step S2527, the CPU 101 determines that there is no point information. The processing of this flowchart ends.

In step S2528, the CPU 101 obtains the next data element as the data element to be inspected. The processing proceeds to step S2522.

FIG. 25C illustrates a flowchart of the point mark field presence/absence determination processing performed in the eighth exemplary embodiment. The processing of this flowchart is performed by the CPU 101 reading a program stored in the ROM 102 into the DRAM 103 and running the program. Where there is a point mark field below a mark-up field is determined by the processing of this flowchart.

In step S2529, the CPU 101 sets coordinates DEF_GD_HEIGHT/2 below the position of the center of gravity of the data element of interest. The processing proceeds to step S2530. By this processing, the coordinates can be moved to the start position of a point mark field area.

In step S2530, the CPU 101 obtains the pixel value at the moved coordinates. The processing proceeds to step S2531.

In step S2531, the CPU 101 checks whether the obtained pixel value exceeds an edge determination threshold. If the pixel value exceeds the edge determination threshold (YES in step S2531), the processing proceeds to step S2532. If the pixel value does not exceed the edge determination threshold (NO in step S2531), the processing proceeds to step S2533. The edge determination threshold is separately appropriately defined.

In step S2532, the CPU 101 increments an edge count. The processing proceeds to step S2533.

In step S2533, the CPU 101 checks whether the edge count exceeds a point mark field presence/absence threshold. If the edge count exceeds the point mark field presence/absence threshold (YES in step S2533), the processing proceeds to step S2534. If the edge count does not exceed the point mark field presence/absence threshold (NO in step S2533), the processing proceeds to step S2535. The point mark field presence/absence threshold is separately appropriately defined.

In step S2534, the CPU 101 determines that there is a point mark field. The processing of this flowchart ends.

In step S2535, the CPU 101 checks whether the number of pixels inspected so far exceeds the height of a point mark field area. If the number of inspected pixels is greater than or equal to DEF_GD_HEIGHT (YES in step S2535), the processing proceeds to step S2536. If the number of inspected pixels is less than DEF_GD_HEIGHT (NO in step S2535), the processing proceeds to step S2537.

In step S2536, the CPU 101 determines that there is no point mark field. The processing of this flowchart ends.

In step S2537, the CPU 101 shifts the coordinates currently referred to downward by one pixel. The processing proceeds to step S2530.

FIG. 25D illustrates a flowchart of the mark-up field marking type obtaining processing performed in the eighth exemplary embodiment. The processing of this flowchart is performed by the CPU 101 reading a program stored in the ROM 102 into the DRAM 103 and running the program. Marking type information corresponding to the mark-up field is obtained by the processing of this flowchart.

In step S2538, the CPU 101 checks whether the recognition result of the data element is ∘. If the recognition result is ∘ (YES in step S2538), the processing proceeds to step S2540. If the recognition result is not ∘ (NO in step S2538), the processing proceeds to step S2539.

In step S2539, the CPU 101 checks whether the recognition result of the data element is x. If the recognition result is x (YES in step S2539), the processing proceeds to step S2541. If the recognition result is not x (NO in step S2539), the processing proceeds to step S2542.

In step S2540, the CPU 101 determines that the marking type is JUDGEMARK_CORRECT. The processing of this flowchart ends.

In step S2541, the CPU 101 determines that the marking type is JUDGEMARK_INCORRECT. The processing of this flowchart ends.

In step S2542, the CPU 101 determines that the marking type is JUDGEMARK_PARTIAL. The processing of this flowchart ends.

FIG. 25E illustrates a flowchart of the point mark field marking type obtaining processing performed in the eighth exemplary embodiment. This flowchart is performed by the CPU 101 reading a program stored in the ROM 102 into the DRAM 103 and running the program. Marking type information corresponding to the point mark field is obtained by the processing of this flowchart.

In step S2543, the CPU 101 checks whether the recognition result of the data element is ∘. If the recognition result is ∘ (YES in step S2543), the processing proceeds to step S2544. If the recognition result is not ∘ (NO in step S2543), the processing proceeds to step S2545.

In step S2544, the CPU 101 determines that the marking type is DIGITMARK_CORRECT. The processing of this flowchart ends.

In step S2545, the CPU 101 determines that the marking type is DIGITMARK_PARTIAL. The processing of this flowchart ends.

As described above, a system can be provided that can generate answer sheet pattern data through image analysis of image data on correct-answer and answer sheets and perform marking and aggregation even if there is no answer sheet pattern DB.

The exemplary embodiments described above are just a few examples of embodiment, and the present disclosure is not limited to the foregoing exemplary embodiments in practice.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2021-114970, which was filed on Jul. 12, 2021 and which is hereby incorporated by reference herein in its entirety.

What is claimed is:

1. A system comprising:
a print unit configured to print an answer sheet including a plurality of free-form answer fields and a plurality of marking fields, the plurality of marking fields being configured to mark answers written in the respective plurality of free-form answer fields;
a reading unit configured to read the answer sheet printed by the print unit;
a marking unit configured to mark the answers based at least on description of the plurality of marking fields included in the answer sheet read by the reading unit; and
an aggregation unit configured to aggregate results of marking made by the marking unit.

2. The system according to claim 1, further comprising an acceptance unit configured to accept the number of free-form questions,
wherein the print unit is configured to print the answer sheet including as many answer fields as the number accepted by the acceptance unit.

3. The system according to claim 1,
wherein the answer sheet further includes a multiple-choice answer field, and
wherein the marking unit is configured to mark the answers based on description of the multiple-choice answer field and the description of the marking fields included in the answer sheet read by the reading unit.

4. The system according to claim 3, further comprising a specification unit configured to specify the number of multiple-choice questions,
wherein the answer sheet includes as many multiple-choice answer fields as the number specified by the specification unit.

5. The system according to claim 1, further comprising an identification unit configured to identify positions of the marking fields included in the answer sheet read by the reading unit based on information indicating the positions of the marking fields included in the answer sheet,
wherein the marking unit is configured to mark the answers based on description of the marking fields located at the positions identified by the identification unit.

6. The system according to claim 1, further comprising a provision unit configured to provide a result aggregated by the aggregation unit.

7. The system according to claim 1, further comprising a setting unit configured to set point information about each of a plurality of free-form questions corresponding to the plurality of free-form answer fields,
wherein the answers are marked based on the description of the plurality of marking fields included in the answer sheet read by the reading unit and the point information set by the setting unit.

8. The system according to claim 1, wherein the plurality of marking fields includes marking fields each configured to give partial marks.

9. The system according to claim 1, further comprising a rearrangement unit configured to rearrange the plurality of free-form answer fields based on a user's instruction.

10. The system according to claim 1, further comprising a change unit configured to change each of the plurality of free-form answer fields in size based on a user's instruction.

11. A control method for a system, the method comprising:
printing an answer sheet including a plurality of free-form answer fields and a plurality of marking fields, the plurality of marking fields being configured to mark answers written in the respective plurality of free-form answer fields;
reading the printed answer sheet;
marking the answers based at least on description of the plurality of marking fields included in the read answer sheet; and
aggregating results of markings made.

12. The control method for a system according to claim 11, further comprising accepting the number of free-form questions,
wherein the printed answer sheet includes as many answer fields as the number accepted.

13. The control method for a system according to claim 11,
wherein the answer sheet further includes a multiple-choice answer field, and
wherein the answers are marked based on description of the multiple-choice answer field and the description of the marking fields included in the read answer sheet.

14. The control method for a system according to claim 13, further comprising specifying the number of multiple-choice questions,
wherein the answer sheet includes as many multiple-choice answer fields as the specified number.

15. The control method for a system according to claim 11, further comprising identifying positions of the marking fields included in the read answer sheet based on information indicating the positions of the marking fields included in the answer sheet,
wherein the answers are marked based on the description of the marking fields located at the specified positions.

16. The control method for a system according to claim 11, further comprising providing an aggregated result.

17. The control method for a system according to claim 11, further comprising setting point information about each of a plurality of free-form questions,
wherein the answers are marked based on the description of the plurality of marking fields included in the read answer sheet and the set point information.

18. The control method for a system according to claim 11, wherein the plurality of marking fields includes marking fields each configured to give partial marks.

19. The control method for a system according to claim 11, further comprising rearranging the plurality of free-form answer fields based on a user's instruction.

20. A computer-readable storage medium storing a program for causing a computer to perform a control method for a system, the control method comprising:
printing an answer sheet including a plurality of free-form answer fields and a plurality of marking fields, the plurality of marking fields being configured to mark answers written in the respective plurality of free-form answer fields;
reading the printed answer sheet;
marking the answers based at least on description of the plurality of marking fields included in the read answer sheet; and
aggregating results of marking made.
